(19) United States
(12) Patent Application Publication
(10) Pub. No.: US 2022/0044183 A1
(43) Pub. Date: Feb. 10, 2022

(54) ENGINEER RECERTIFICATION ASSISTANT

(71) Applicant: Wi-Tronix, LLC, Bolingbrook, IL (US)

(72) Inventors: Lawrence B. Jordan, Bolingbrook, IL (US); Mihir Phadke, Bolingbrook, IL (US); Frank Messina, Bolingbrook, IL (US); Roger Martinez, Bolingbrook, IL (US); Divya Dinesh, Bolingbrook, IL (US)

(73) Assignee: Wi-Tronix, LLC, Bolingbrook, IL (US)

(21) Appl. No.: 17/394,135

(22) Filed: Aug. 4, 2021

Related U.S. Application Data
(60) Provisional application No. 63/061,548, filed on Aug. 5, 2020.

(51) Int. Cl. G06Q 10/06; G06Q 50/26; G06Q 30/00; G06N 3/08; G01C 21/16; B61L 25/02; B61L 27/00

(52) U.S. Cl. CPC G06Q 10/06398; G06Q 50/26; G06Q 30/018; B61L 27/0094; G01C 21/16; B61L 25/028; G06N 3/08

(57) ABSTRACT

An engineer recertification assistant that utilizes a real-time data acquisition and recording system (DARS), a DARS viewer, and a video analytics system for mobile assets. DARS includes a data recorder, an onboard data manager, and at least one local memory module. The video analytics system processes video data from at least one camera and operational data from the data recorder for critical events and regulatory requirements based on a mobile asset operator's operational performance. The processed video data and operational data is display, along with episodes, exceptions, and user comments, on a display device featuring a web portal. The engineer recertification assistant can further determine an automated score-based recommendation for certification or decertification of the mobile asset operator or can directly certify or decertify the mobile asset operator for gross non-compliance.

### CROSS-REFERENCE TO RELATED APPLICATION(S)

This application claims priority to U.S. Provisional Application No. 63/061,548, filed Aug. 5, 2020, to the extent allowed by law and the contents of which are incorporated herein by reference in the entireties.

The disclosure of this application, as shown and described below, may be used in connection with Applicant's U.S. Provisional Application No. 61/624,142, filed Apr. 13, 2012, Applicant's U.S. Non-provisional application Ser. No. 13/861,826, filed Apr. 12, 2013, now U.S. Pat. No. 9,285,294, issued Mar. 15, 2016, Applicant's U.S. Non-provisional application Ser. No. 14/608,423, filed Jan. 29, 2015, now U.S. Pat. No. 9,285,295, issued Mar. 15, 2016, Applicant's U.S. Non-provisional application Ser. No. 14/996,925, filed Jan. 15, 2016, now U.S. Pat. No. 9,915,535, issued Mar. 13, 2018, Applicant's U.S. Provisional Application No. 62/337,227, filed May 16, 2016, Applicant's U.S. Non-provisional application Ser. No. 15/595,650, filed May 15, 2017, now U.S. Pat. No. 9,934,623, issued Apr. 3, 2018, Applicant's U.S. Non-provisional application Ser. No. 15/907,486, filed Feb. 28, 2018, now U.S. Pat. No. 10,445,951, issued Oct. 15, 2019, Applicant's U.S. Provisional Application No. 62/337,225, filed May 16, 2016, Applicant's U.S. Non-provisional application Ser. No. 15/595,689, filed May 15, 2017, now U.S. Pat. No. 10,410,441, issued Sep. 10, 2019, Applicant's co-pending U.S. Non-provisional application Ser. No. 16/385,745, filed Apr. 16, 2019, Applicant's U.S. Provisional Application No. 62/337,228, filed May 16, 2016, Applicant's U.S. Non-provisional application Ser. No. 15/595,712, filed May 15, 2017, now U.S. Pat. No. 10,392,038, issued Aug. 27, 2019, Applicant's U.S. Provisional Application No. 62/825,943, filed Mar. 29, 2019, Applicant's U.S. Provisional Application No. 62/829,730, filed Apr. 5, 2019, and Applicant's co-pending U.S. Non-provisional application Ser. No. 16/833,590, filed Mar. 28, 2020, the contents of which are incorporated herein by reference in their entireties. The entire disclosures of each of the above are incorporated herein by reference. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

### TECHNICAL FIELD

This disclosure relates to the automation of the process for assessing the skills performance of a railroad train operator or engineer who are responsible for the safe movement of high value mobile railroad assets.

### BACKGROUND

High value mobile assets such as locomotives, aircraft, mass transit systems, mining equipment, transportable medical equipment, cargo, marine vessels, and military vessels typically employ onboard data acquisition and recording “black box” systems and/or “event recorder” systems. These data acquisition and recording systems, such as event data recorders or flight data recorders, log a variety of system parameters used for incident investigation, crew performance evaluation, fuel efficiency analysis, maintenance planning, and predictive diagnostics. A typical data acquisition and recording system comprises digital and analog inputs, as well as pressure switches and pressure transducers, which record data from various onboard sensor devices. Recorded data may include such parameters as speed, distance traveled, location, fuel level, engine revolution per minute (RPM), fluid levels, operator controls, pressures, current and forecasted weather conditions and ambient conditions. In addition to the basic event and operational data, video and audio event/data recording capabilities are also deployed on many of these same mobile assets. Typically, data is extracted from data recorders, after an incident has occurred involving an asset and investigation is required, once the data recorder has been recovered. Certain situations may arise where the data recorder cannot be recovered or the data is otherwise unavailable. In these situations, the data, such as event and operational data, video data, and audio data, acquired by the data acquisition and recording system is needed promptly regardless of whether physical access to the data acquisition and recording system or the data is available.

### SUMMARY

This disclosure relates generally to an engineer recertification assistant used for certification or decertification of an engineer or operator in high value mobile assets. The teachings herein can provide real-time, or near real-time, access to data, such as event and operational data, video data, and audio data, recorded by a real-time data acquisition and recording system on a high value mobile asset. One implementation of a method for automating the assessment of performance skills of a specified mobile asset operator, including receiving, using a web portal, a request from a user comprising the specified mobile asset operator and a specified time range; receiving, using a data acquisition and recording system, data related to the mobile asset operator and the specified time range, the data based on at least one signal from at least one of: at least one data source onboard a mobile asset, the at least one data source onboard the mobile asset comprising at least one of at least one camera and at least one data recorder of the data acquisition and recording system; and at least one data source remote from the mobile asset; processing, using an artificial intelligence component of a video analytics system, the data into processed data; and displaying, using the web portal, the processed data including at least one video on a display device.

One implementation of a system for automating the assessment of performance skills of a specified mobile asset operator includes a web portal adapted to receive a request from a user comprising the specified mobile asset operator of a mobile asset and a specified time range; a data acquisition and recording system onboard the mobile asset adapted to receive data related to the specified mobile asset operator and the specified time range, the data based on at least one signal from at least one of at least one data source onboard the mobile asset comprising at least one of at least one camera and at least one data recorder of the data acquisition and recording system and at least one data source remote from the mobile asset; an artificial intelligence component of a video analytics system adapted to process the data into processed data; and the web portal adapted to display the processed data including at least one video on a display device

Variations in these and other aspects of the disclosure will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 illustrates a field implementation of a first embodiment of an exemplary real-time data acquisition and recording system in accordance with implementations of this disclosure;

FIG. 2 illustrates a field implementation of a second embodiment of the exemplary real-time data acquisition and recording system in accordance with implementations of this disclosure;

FIG. 3 is a flow diagram of a process for recording data and/or information from a mobile asset in accordance with implementations of this disclosure;

FIG. 4 is a flow diagram of a process for appending data and/or information from the mobile asset after a power outage in accordance with implementations of this disclosure;

FIG. 5 is a diagram that illustrates exemplary interim record blocks and full record blocks saved to a crash hardened memory module in accordance with implementations of this disclosure;

FIG. 6 is a diagram that illustrates exemplary interim record blocks in the crash hardened memory module prior to a power outage and after restoration of power in accordance with implementations of this disclosure;

FIG. 7 is a diagram that illustrates an exemplary record segment in the crash hardened memory module after power has been restored in accordance with implementations of this disclosure;

FIG. 8 illustrates a field implementation of a first embodiment of a real-time data acquisition and recording system viewer in accordance with implementations of this disclosure;

FIG. 9 is a flow diagram of a process for recording video data, audio data, and/or information from a mobile asset in accordance with implementations of this disclosure;

FIG. 10 is a flow diagram of a process for recording video data, audio data, and/or information from the mobile asset in accordance with implementations of this disclosure;

FIG. 11 is a flow diagram that illustrates an exemplary fisheye view of a 360 degrees camera of the real-time data acquisition and recording system viewer in accordance with implementations of this disclosure;

FIG. 12 is a diagram that illustrates an exemplary panorama view of the 360 degrees camera of the real-time data acquisition and recording system viewer in accordance with implementations of this disclosure;

FIG. 13 is a diagram that illustrates an exemplary quad view of the 360 degrees camera of the real-time data acquisition and recording system viewer in accordance with implementations of this disclosure;

FIG. 14 is a diagram that illustrates an exemplary dewarped view of the 360 degrees camera of the real-time data acquisition and recording system viewer in accordance with implementations of this disclosure;

FIG. 15 illustrates a field implementation of a first embodiment of a data acquisition and recording system video content analysis system in accordance with implementations of this disclosure;

FIG. 16A is a diagram that illustrates exemplary track detection in accordance with implementations of this disclosure;

FIG. 16B is a diagram that illustrates exemplary track detection and switch detection in accordance with implementations of this disclosure;

FIG. 16C is a diagram that illustrates exemplary track detection, count the number of tracks, and signal detection in accordance with implementations of this disclosure;

FIG. 16D is a diagram that illustrates exemplary crossing and track detection in accordance with implementations of this disclosure;

FIG. 16E is a diagram that illustrates exemplary dual overhead signal detection in accordance with implementations of this disclosure;

FIG. 16F is a diagram that illustrates exemplary multi-track detection in accordance with implementations of this disclosure;

FIG. 16G is a diagram that illustrates exemplary switch and track detection in accordance with implementations of this disclosure;

FIG. 16H is a diagram that illustrates exemplary switch detection in accordance with implementations of this disclosure;

FIG. 17 is a flow diagram of a process for determining an internal status of the mobile asset in accordance with implementations of this disclosure;

FIG. 18 is a flow diagram of a process for determining object detection and obstruction detection occurring externally to the mobile asset in accordance with implementations of this disclosure;

FIG. 19 illustrates a field implementation of a seventh embodiment of an exemplary real-time data acquisition and recording system in accordance with implementations of this disclosure;

FIG. 20 is a diagram that illustrates exemplary signal detection of an automated signal compliance monitoring and alerting system in accordance with implementations of this disclosure;

FIG. 21 is a flow diagram of a first embodiment of a process for determining signal compliance in accordance with implementations of this disclosure;

FIG. 22 is a diagram of a first embodiment of an engineer recertification assistant, showing a digital video recorder (DVR) video clips screenshot, in accordance with implementations of this disclosure;

FIG. 23 is a diagram of the first embodiment of the engineer recertification assistant, showing an existing webpage enhanced with engineer recertification pre-defined events such as signal crossings, in accordance with implementations of this disclosure;

FIG. 24 is a diagram of the first embodiment of the engineer recertification assistant, showing screenshots and efficiency, in accordance with implementations of this disclosure;

FIG. 25 is a flow diagram of the first embodiment of a process for assessing skills performance, showing a target process, in accordance with implementations of this disclosure;

FIG. 26 is a screenshot of the first embodiment of the engineer recertification assistant, showing a user selecting an engineer monitoring ride, in accordance with implementations of this disclosure;

FIG. 27 is a screenshot of the first embodiment of the engineer recertification assistant, showing the automatic download of video for events of interest, in accordance with implementations of this disclosure;

FIG. 28 is a diagram of the first embodiment of the engineer recertification assistant, showing a plurality of screenshots depicting sections of the user's engineer evaluation report rules, in accordance with implementations of this disclosure;

FIG. 29 is a screenshot of the first embodiment of the engineer recertification assistant, showing report generation, in accordance with implementations of this disclosure;

FIG. 30 is a diagram of the first embodiment of the engineer recertification assistant, showing an engineer evaluation report and an operator scorecard, in accordance with implementations of this disclosure;

FIG. 31 is a screenshot of the first embodiment of the engineer recertification assistant, showing a live demonstration of downloaded video, thumbnails, and icons of a train passing a wayside signal, in accordance with implementations of this disclosure;

FIG. 32 is a screenshot of the first embodiment of the engineer recertification assistant, showing a road foreman of engineers (RFE) user deciding an asset and time range the user wants to evaluate an engineer for on the DVR video download webpage, in accordance with implementations of this disclosure;

FIG. 33 is a flow diagram of the first embodiment of the process for assessing skills performance in accordance with an implementation of this disclosure;

FIG. 34 is a flow diagram showing the operation of the emergency brake with impact detection system in accordance with implementations of this disclosure;

FIG. 35 is a flow diagram showing the operation of the fuel compensation using accelerometer-based pitch and roll of the present invention;

FIG. 36 is a flow diagram showing the operation of the potential rough operating condition detection using the accelerometer of the present invention;

FIG. 37 is a flow diagram showing the operation of the engine running detection system using an accelerometer of the present invention;

FIG. 38 is a flow diagram showing the operation of the inertial navigation, and dead reckoning, system of the present invention; and

FIG. 39 is a diagram showing the first embodiment of the mobile asset data recorder and transmitter system, showing the components, in accordance with implementations of this disclosure.

### DETAILED DESCRIPTION

A first embodiment of a real-time data acquisition and recording system described herein provides real-time, or near real-time, access to a wide range of data, such as event and operational data, video data, and audio data, related to a high value asset to remotely located users such as asset owners, operators and investigators. The data acquisition and recording system records data, via a data recorder, relating to the asset and streams the data to a remote data repository and remotely located users prior to, during, and after an incident has occurred. The data is streamed to the remote data repository in real-time, or near real-time, making information available at least up to the time of an incident or emergency situation, thereby virtually eliminating the need to locate and download the “black box” in order to investigate an incident involving the asset and eliminating the need to interact with the data recorder on the asset to request a download of specific data, to locate and transfer files, and to use a custom application to view the data. The system of the present disclosure retains typical recording capability and adds the ability to stream data to a remote data repository and remote end user prior to, during, and after an incident. In the vast majority of situations, the information recorded in the data recorder is redundant and not required as data has already been acquired and stored in the remote data repository.

Prior to the system of the present disclosure, data was extracted from the “black box” or “event recorder” after an incident had occurred and an investigation was required. Data files containing time segments recorded by the “black box” had to be downloaded and retrieved from the “black box” and then viewed by a user with proprietary software. The user would have to obtain physical or remote access to the asset, select the desired data to be downloaded from the “black box,” download the file containing the desired information to a computing device, and locate the appropriate file with the desired data using a custom application that operates on the computing device. The system of the present disclosure has eliminated the need for the user to perform these steps, only requiring the user to use a common web browser to navigate to the desired data. The remotely located user may access a common web browser to navigate to desired data relating to a selected asset to view and analyze the operational efficiency and safety of assets in real-time or near real-time.

The remotely located user, such as an asset owner, operator, and/or investigator, may access a common web browser to navigate to live and/or historic desired data relating to a selected asset to view and analyze the operational efficiency and safety of assets in real-time or near real-time. The ability to view operations in real-time, or near real-time, enables rapid evaluation and adjustment of behavior. During an incident, for example, real-time information and/or data can facilitate triaging the situation and provide valuable information to first responders. During normal operation, for example, near real-time information and/or data can be used to audit crew performance and to aid network wide situational awareness.

Data may include, but is not limited to, analog and frequency parameters such as speed, pressure, temperature, current, voltage, and acceleration which originate from the asset and/or nearby assets, Boolean data such as switch positions, actuator position, warning light illumination, and actuator commands, global positioning system (GPS) data and/or geographic information system (GIS) data such as position, speed, and altitude, internally generated information such as the regulatory speed limit for an asset given its current position, video and image information from cameras located at various locations in, on or in the vicinity of the asset, audio information from microphones located at various locations in, on or in vicinity of the asset, information about the operational plan for the asset that is sent to the asset from a data center such as route, schedule, and cargo manifest information, information about the environmental conditions, including current and forecasted weather conditions, of the area in which the asset is currently operating in or is planned to operate in, asset control status and operational data generated by systems such as positive train control (PTC) in locomotives, and data derived from a combination from any of the above including, but not limited to, additional data, video, and audio analysis and analytics.

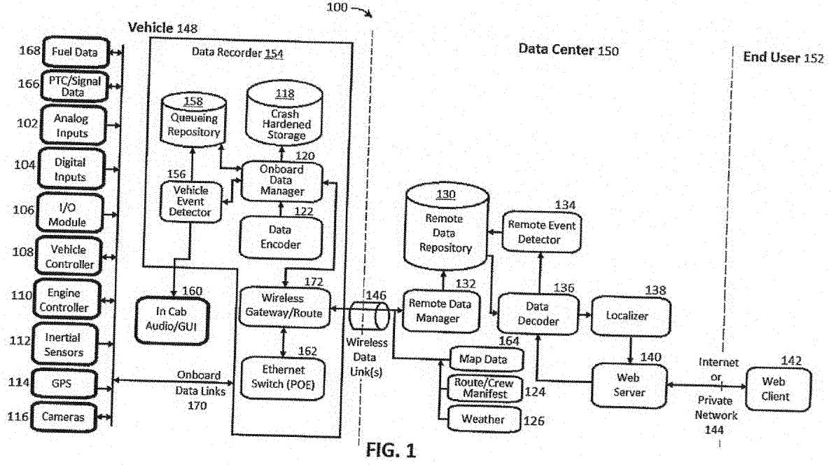

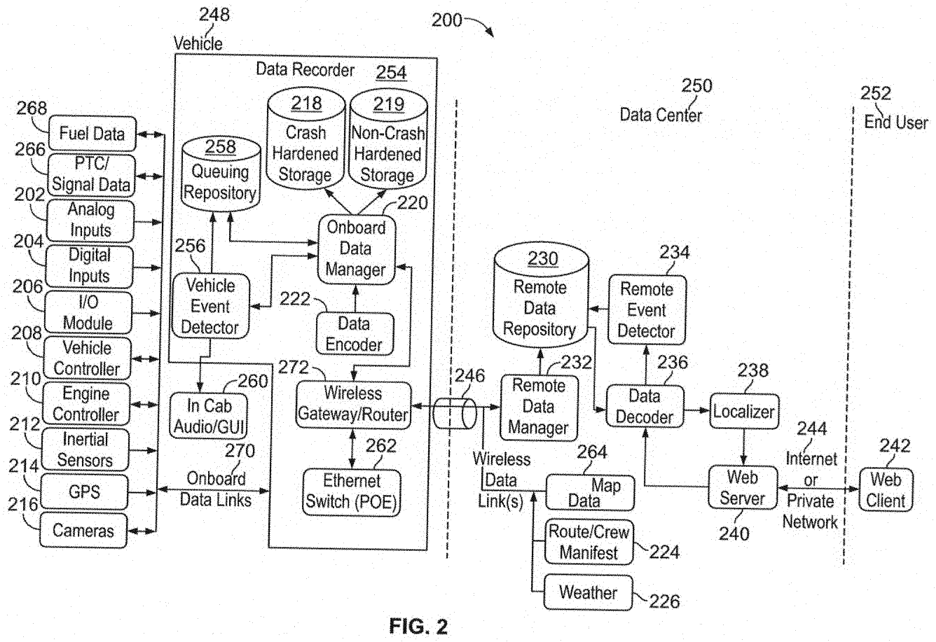

FIGS. 1 and 2 illustrate a field implementation of a first embodiment and a second embodiment, respectively, of an exemplary real-time data acquisition and recording system (DARS) 100, 200 in which aspects of the disclosure can be implemented. DARS 100, 200 is a system that delivers real time information to remotely located end users from a data recording device. DARS 100, 200 includes a data recorder 154, 254 that is installed on a vehicle or mobile asset 148, 248 and communicates with any number of various information sources through any combination of onboard wired and/or wireless data links 170, 270, such as a wireless gateway/router, or off board information sources via a data center 150, 250 of DARS 100, 200 via data links such as wireless data links 146. Data recorder 154, 254 comprises an onboard data manager 120, 220, a data encoder 122, 222, a vehicle event detector 156, 256, a queueing repository 158, 258, and a wireless gateway/router 172, 272. Additionally, in this implementation, data recorder 154, 254 can include a crash hardened memory module 118, 218 and/or an Ethernet switch 162, 262 with or without power over Ethernet (POE). An exemplary hardened memory module 118, 218 can be, for example, a crashworthy event recorder memory module that complies with the Code of Federal Regulations and/or the Federal Railroad Administration regulations, a crash survivable memory unit that complies with the Code of Federal Regulations and/or the Federal Aviation Administration regulations, a crash hardened memory module in compliance with any applicable Code of Federal Regulations, or any other suitable hardened memory device as is known in the art. In the second embodiment, shown in FIG. 2, the data recorder 254 can further include an optional non-crash hardened removable storage device 219.

The wired and/or wireless data links 170, 270 can include any one of or combination of discrete signal inputs, standard or proprietary Ethernet, serial connections, and wireless connections. Ethernet connected devices may utilize the data recorder's 154, 254 Ethernet switch 162, 262 and can utilize POE. Ethernet switch 162, 262 may be internal or external and may support POE. Additionally, data from remote data sources, such as a map component 164, 264, a route/crew manifest component 124, 224, and a weather component 126, 226 in the implementation of FIGS. 1 and 2, is available to the onboard data manager 120, 220 and the vehicle event detector 156, 256 from the data center 150, 250 through the wireless data link 146, 246 and the wireless gateway/router 172, 272.

Data recorder 154, 254 gathers data or information from a wide variety of sources, which can vary widely based on the asset's configuration, through onboard data links 170, 270. The data encoder 122, 222 encodes at least a minimum set of data that is typically defined by a regulatory agency. In this implementation, the data encoder 122, 222 receives data from a wide variety of asset 148, 248 sources and data center 150, 250 sources. Information sources can include any number of components in the asset 148, 248, such as any of analog inputs 102, 202, digital inputs 104, 204, I/O module 106, 206, vehicle controller 108, 208, engine controller 110, 210, inertial sensors 112, 212, global positioning system (GPS) 114, 214, cameras 116, 216, positive train control (PTC)/signal data 166, 266, fuel data 168, 268, cellular transmission detectors (not shown), internally driven data and any additional data signals, and any number of components in the data center 150, 250, such as any of the route/crew manifest component 124, 224, the weather component 126, 226, the map component 164, 264, and any additional data signals. The data encoder 122, 222 compresses or encodes the data and time synchronizes the data in order to facilitate efficient real-time transmission and replication to a remote data repository 130, 230. The data encoder 122, 222 transmits the encoded data to the onboard data manager 120, 220 which then saves the encoded data in the crash hardened memory module 118, 218 and the queuing repository 158, 258 for replication to the remote data repository 130, 230 via a remote data manager 132, 232 located in the data center 150, 250. Optionally, the onboard data manager 120, 220 can save a tertiary copy of the encoded data in the non-crash hardened removable storage device 219 of the second embodiment shown in FIG. 2. The onboard data manager 120, 220 and the remote data manager 132, 232 work in unison to manage the data replication process. A single remote data manager 132, 232 in the data center 150, 250 can manage the replication of data from a plurality of assets 148, 248.

The data from the various input components and data from an in-cab audio/graphical user interface (GUI) 160, 260 are sent to a vehicle event detector 156, 256. The vehicle event detector 156, 256 processes the data to determine whether an event, incident or other predefined situation involving the asset 148, 248 has occurred. When the vehicle event detector 156, 256 detects signals that indicate a predefined event occurred, the vehicle event detector 156, 256 sends the processed data that a predefined event occurred along with supporting data surrounding the predefined event to the onboard data manager 120, 220. The vehicle event detector 156, 256 detects events based on data from a wide variety of sources, such as the analog inputs 102, 202, the digital inputs 104, 204, the I/O module 106, 206, the vehicle controller 108, 208, the engine controller 110, 210, the inertial sensors 112, 212, the GPS 114, 214, the cameras 116, 216, the route/crew manifest component 124, 224, the weather component 126, 226, the map component 164, 264, the PTC/signal data 166, 266, and the fuel data 168, 268, which can vary based on the asset's configuration. When the vehicle event detector 156, 256 detects an event, the detected asset event information is stored in a queuing repository 158, 258 and can optionally be presented to the crew of the asset 148, 248 via the in-cab audio/graphical user interface (GUI) 160, 260.

The onboard data manager 120, 220 also sends data to the queuing repository 158. In near real-time mode, the onboard data manager 120, 220 stores the encoded data received from the data encoder 122, 222 and any event information in the crash hardened memory module 118, 218 and in the queueing repository 158, 258. In the second embodiment of FIG. 2, the onboard data manager 220 can optionally store the encoded data in the non-crash hardened removable storage device 219. After five minutes of encoded data has accumulated in the queuing repository 158, 258, the onboard data manager 120, 220 stores the five minutes of encoded data to the remote data repository 130, 230 via the remote data manager 132, 232 in the data center 150, 250 over the wireless data link 146, 246 accessed through the wireless gateway/router 172, 272. In real-time mode, the onboard data manager 120, 220 stores the encoded data received from the data encoder 122, 222 and any event information to the crash hardened memory module 118, 218, and optionally in the non-crash hardened removable storage device 219 of FIG. 2, and to the remote data repository 130, 230 via the remote data manager 132, 232 in the data center 150, 250 over the wireless data link 146, 246 accessed through the wireless gateway/router 172, 272. The onboard data manager 120, 220 and the remote data manager 132, 232 can communicate over a variety of wireless communications links, such as Wi-Fi, cellular, satellite, and private wireless systems utilizing the wireless gateway/router 172, 272. Wireless data link 146, 246 can be, for example, a wireless local area network (WLAN), wireless metropolitan area network (WMAN), wireless wide area network (WWAN), a private wireless system, a cellular telephone network or any other means of transferring data from the data recorder 154, 254 of DARS 100, 200 to, in this example, the remote data manager 130, 230 of DARS 100, 200. When a wireless data connection is not available, the data is stored in memory and queued in queueing repository 158, 258 until wireless connectivity is restored and the data replication process can resume.

In parallel with data recording, data recorder 154, 254 continuously and autonomously replicates data to the remote data repository 130, 230. The replication process has two modes, a real-time mode and a near real-time mode. In real-time mode, the data is replicated to the remote data repository 130, 230 every second. In near real-time mode, the data is replicated to the remote data repository 130, 230 every five minutes. The rates used for near real-time mode and real-time mode are configurable and the rate used for real-time mode can be adjusted to support high resolution data by replicating data to the remote data repository 130, 230 every 0.10 seconds. When the DARS 100, 200 is in near real-time mode, the onboard data manager 120, 220 queues data in the queuing repository 158, 258 before replicating the data to the remote data manager 132, 232. The onboard data manager 120, 220 also replicates the vehicle event detector information queued in the queueing repository 158, 258 to the remote data manager 132, 232. Near real-time mode is used during normal operation, under most conditions, in order to improve the efficiency of the data replication process.

Real-time mode can be initiated based on events occurring and detected by the vehicle event detector 156, 256 onboard the asset 148, 248 or by a request initiated from the data center 150, 250. A typical data center 150, 250 initiated request for real-time mode is initiated when a remotely located user 152, 252 has requested real-time information from a web client 142, 242. A typical reason for real-time mode to originate onboard the asset 148, 248 is the detection of an event or incident by the vehicle event detector 156, 256 such as an operator initiating an emergency stop request, emergency braking activity, rapid acceleration or deceleration in any axis, or loss of input power to the data recorder 154, 254. When transitioning from near real-time mode to real-time mode, all data not yet replicated to the remote data repository 130, 230 is replicated and stored in the remote data repository 130, 230 and then live replication is initiated. The transition between near real-time mode and real-time mode typically occurs in less than five seconds. After a predetermined amount of time has passed since the event or incident, a predetermined amount of time of inactivity, or when the user 152, 252 no longer desires real-time information from the asset 148, 248, the data recorder 154, 254 reverts to near real-time mode. The predetermined amount of time required to initiate the transition is configurable and is typically set to ten minutes.

When the data recorder 154, 254 is in real-time mode, the onboard data manager 120, 220 attempts to continuously empty its queue to the remote data manager 132, 232, storing the data to the crash hardened memory module 118, 218, and optionally to the non-crash hardened removable storage device 219 of FIG. 2, and sending the data to the remote data manager 132, 232 simultaneously. The onboard data manager 120, 220 also sends the detected vehicle information queued in the queuing repository 158, 258 to the remote data manager 132, 232.

Upon receiving data to be replicated from the data recorder 154, 254, along with data from the map component 164, 264, the route/crew manifest component 124, 224, and the weather component 126, 226, the remote data manager 132, 232 stores the compressed data to the remote data repository 130, 230 in the data center 150, 250 of DARS 100, 200. The remote data repository 130, 230 can be, for example, cloud-based data storage or any other suitable remote data storage. When data is received, a process is initiated that causes a data decoder 136, 236 to decode the recently replicated data for/from the remote data repository 130, 230 and send the decoded data to a remote event detector 134, 234. The remote data manager 132, 232 stores vehicle event information in the remote data repository 130, 230. When the remote event detector 134, 234 receives the decoded data, it processes the decoded data to determine if an event of interest is found in the decoded data. The decoded information is then used by the remote event detector 134, 234 to detect events, incidents, or other predefined situations, in the data occurring with the asset 148, 248. Upon detecting an event of interest from the decoded data, the remote event detector 134, 234 stores the event information and supporting data in the remote data repository 130, 230. When the remote data manager 132, 232 receives remote event detector 134, 234 information, the remote data manager 132, 232 stores the information in the remote data repository 130, 230.

The remotely located user 152, 252 can access information, including vehicle event detector information, relating to the specific asset 148, 248, or a plurality of assets, using the standard web client 142, 242, such as a web browser, or a virtual reality device (not shown) which, in this implementation, can display thumbnail images from selected cameras. The web client 142, 242 communicates the user's 152, 252 requests for information to a web server 140, 240 through a network 144, 244 using common web standards, protocols, and techniques. Network 144, 244 can be, for example, the Internet. Network 144, 244 can also be a local area network (LAN), metropolitan area network (MAN), wide area network (WAN), virtual private network (VPN), a cellular telephone network or any other means of transferring data from the web server 140, 240 to, in this example, the web client 142, 242. The web server 140, 240 requests the desired data from the data decoder 136, 236. The data decoder 136, 236 obtains the requested data relating to the specific asset 148, 248, or a plurality of assets, from the remote data repository 130, 230 upon request from the web server 140, 240. The data decoder 136, 236 decodes the requested data and sends the decoded data to a localizer 138, 238. Localization is the process of converting data to formats desired by the end user, such as converting the data to the user's preferred language and units of measure. The localizer 138, 238 identifies the profile settings set by user 152, 252 by accessing the web client 142, 242 and uses the profile settings to prepare the information being sent to the web client 142, 242 for presentation to the user 152, 252, as the raw encoded data and detected event information is saved to the remote data repository 130, 230 using coordinated universal time (UTC) and international system of units (SI units). The localizer 138, 238 converts the decoded data into a format desired by the user 152, 252, such as the user's 152, 252 preferred language and units of measure. The localizer 138, 238 sends the localized data in the user's 152, 252 preferred format to the web server 140, 240 as requested. The web server 140, 240 then sends the localized data of the asset, or plurality of assets, to the web client 142, 242 for viewing and analysis, providing playback and real-time display of standard video and 360 degrees video. The web client 142, 242 can display and the user 152, 252 can view the data, video, and audio for a single asset or simultaneously view the data, video, and audio for a plurality of assets. The web client 142, 242 can also provide synchronous playback and real-time display of data along with the plurality of video and audio data from both standard and 360 degrees video sources on, in, or in the vicinity of the asset, nearby assets, and/or remotely located sites.

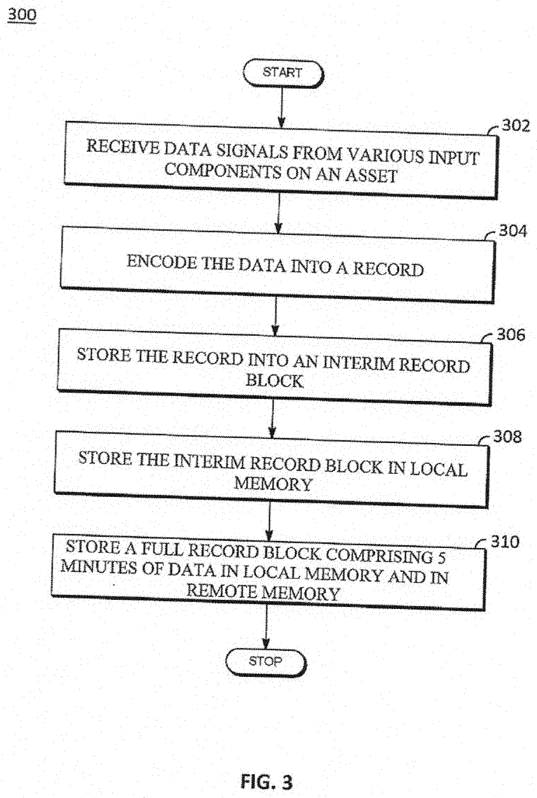

FIG. 3 is a flow diagram showing a process 300 for recording data and/or information from the asset 148, 248 in accordance with an implementation of this disclosure. Data recorder 154, 254 receives data signals from various input components that include physical or calculated data elements from the asset 148, 248 and data center 150, 250, such as speed, latitude coordinates, longitude coordinates, horn detection, throttle position, weather data, map data, and/or route and/or crew data 302. Data encoder 122, 222 creates a record that includes a structured series of bits used to configure and record the data signal information 304. The encoded record is then sent to the onboard data manager 120, 220 that sequentially combines a series of records in chronological order into record blocks that include up to five minutes of data 306. An interim record block includes less than five minutes of data while a full record block includes a full five minutes of data. Each record block includes all the data required to fully decode the included signals, including a data integrity check. At a minimum, a record block must start with a start record and end with an end record.

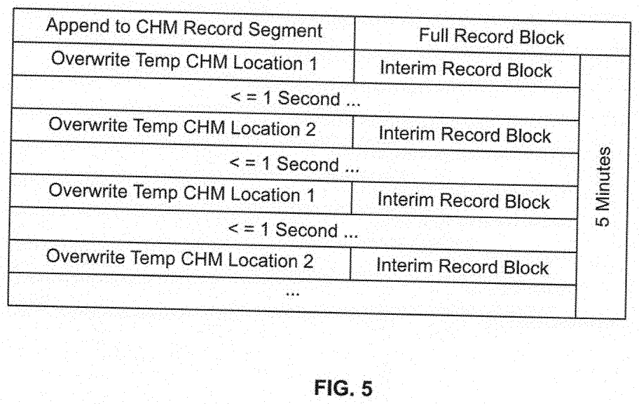

In order to ensure that all of the encoded signal data is saved to the crash hardened memory module 118, and optionally to the non-crash hardened removable storage device 219 of FIG. 2, should the data recorder 154, 254 lose power or be subjected to extreme temperatures or mechanical stresses due to a collision or other catastrophic event, the onboard data manager 120, 220 stores interim record blocks in the crash hardened memory module 118 at a predetermined rate 308, and optionally in the non-crash hardened removable storage device 219 of FIG. 2, where the predetermined rate is configurable and/or variable, as shown in FIG. 5 in an exemplary representation. Interim record blocks are saved at least once per second but can also be saved as frequently as once every tenth of a second. The rate at which interim record blocks are saved depends on the sampling rates of each signal. Every interim record block includes the full set of records since the last full record block. Data recorder 154, 254 can alternate between two temporary storage locations in the crash hardened memory module 118, 218, and optionally in the non-crash hardened removable storage device 219 of FIG. 2, when recording each interim record block to prevent the corruption or loss of more than one second of data when the data recorder 154, 254 loses power while storing data to the crash hardened memory module 118, 218 or the optional non-crash hardened removable storage device 219 of the data recorder 254 of FIG. 2. Each time a new interim record block is saved to a temporary crash hardened memory location it will overwrite the existing previously stored interim record block in that location.

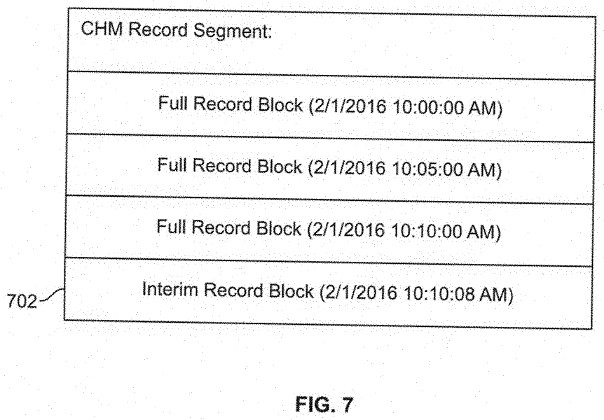

Every five minutes, in this implementation, when the data recorder 154, 254 is in near real-time mode, the onboard data manager 120, 220 stores a full record block including the last five minutes of encoded signal data into a record segment in the crash hardened memory module 118, 218, shown in FIG. 7, and sends a copy of the full record block to the remote data manager 132, 232 to be stored in the remote data repository 130, 230 for a predetermined retention period such as two years 310. The crash hardened memory module 118, 218, and/or the optional non-crash hardened removable storage device 219 of the data recorder 254 of FIG. 2, stores a record segment of the most recent record blocks for a mandated storage duration, which in this implementation is the federally mandated duration that the data recorder 154, 254 must store operational and/or video data in the crash hardened memory module 118, 218 with an additional 24 hour buffer, and is then overwritten.

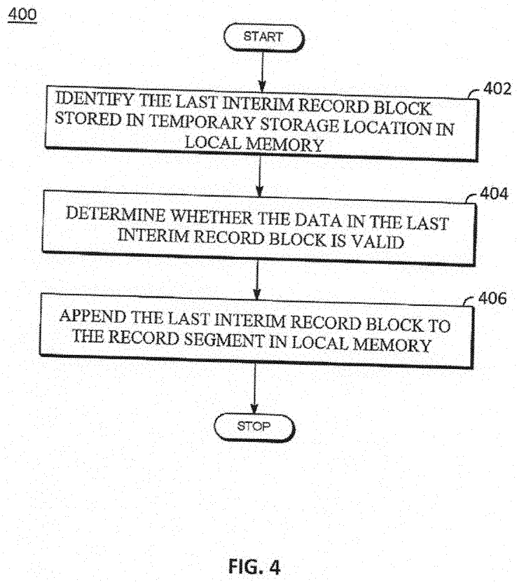

FIG. 4 is a flow diagram showing a process 400 for appending data and/or information from the asset 148, 248 after a power outage in accordance with an implementation of this disclosure. Once power is restored, the data recorder 154, 254 identifies the last interim record block that was stored in one of the two temporary crash hardened memory locations 402 and validates the last interim record block using the 32 bit cyclic redundancy check that is included in the end record of every record block 404. The validated interim record block is then appended to the crash hardened memory record segment and that record segment, which can contain up to five minutes of data prior to the power loss, is sent to the remote data manager 132, 232 to be stored for the retention period 406. The encoded signal data is stored to the crash hardened memory module 118, 218, and/or the optional non-crash hardened removable storage device 219 of the data recorder 254 of FIG. 2, in a circular buffer of the mandated storage duration. Since the crash hardened memory record segment is broken up into multiple record blocks, the data recorder 154, 254 removes older record blocks when necessary to free up memory space each time a full record block is saved to crash hardened memory module 118, 218, and/or the optional non-crash hardened removable storage device 219 of the data recorder 254 of FIG. 2.

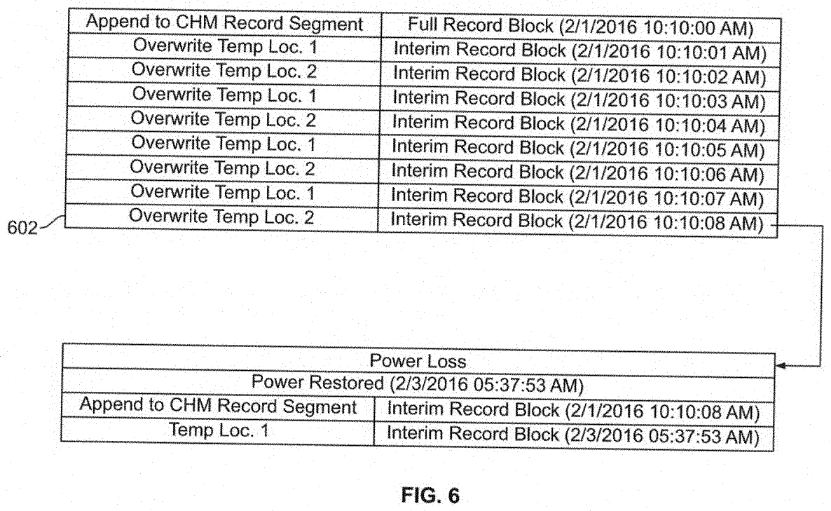

FIG. 6 is a diagram that illustrates exemplary interim record blocks prior to a loss of power and after restoration of power to the data recorder 154, 254. When the interim record block stored in temporary location 2 at (2/1/2016 10:10:08 AM) 602 is valid, that interim record block is appended to the record segment 702 (FIG. 7) in the crash hardened memory module 118, 218, and/or the optional non-crash hardened removable storage device 219 of the data recorder 254 of FIG. 2, as shown in FIG. 7. When the interim record block stored in temporary location 2 at (2/1/2016 10:10:08 AM) is not valid, the interim record block in temporary location 1 at (2/1/2016 10:10:07 AM) is validated and, if valid, is appended to the record segment in the crash hardened memory module 118, 218, and/or the optional non-crash hardened removable storage device 219 of the data recorder 254 of FIG. 2.

Whenever any record block needs to be saved in crash hardened memory module 118, 218, and/or the optional non-crash hardened removable storage device 219 of the data recorder 254 of FIG. 2, the record segment is flushed to the disk immediately. Since the data recorder 154, 254 alternates between two different temporary storage locations when saving interim record blocks, there is always one temporary storage location that is not being modified or flushed to crash hardened memory or non-crash hardened removable storage device, thereby ensuring that at least one of the two interim record blocks stored in the temporary storage locations is valid and that the data recorder 154, 254 will not lose more than one second at most of data whenever the data recorder 154, 254 loses power. Similarly, when the data recorder 154, 254 is writing data to the crash hardened memory module 118, 218, and/or the optional non-crash hardened removable storage device 219 of the data recorder 254 of FIG. 2, every tenth of a second, the data recorder 154, 254 will not lose more than one tenth of a second at most of data whenever the data recorder 154, 254 loses power.

For simplicity of explanation, process 300 and process 400 are depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

A third embodiment of a real-time data acquisition and recording system and viewer described herein provides real-time, or near real-time, access to a wide range of data, such as event and operational data, video data, and audio data, of a high value asset to remotely located users such as asset owners, operators and investigators. The data acquisition and recording system records data, via a data recorder, relating to the asset and streams the data to a remote data repository and remotely located users prior to, during, and after an incident has occurred. The data is streamed to the remote data repository in real-time, or near real-time, making information available at least up to the time of an incident or emergency situation, thereby virtually eliminating the need to locate and download the “black box” in order to investigate an incident involving the asset and eliminating the need to interact with the data recorder on the asset to request a download of specific data, to locate and transfer files, and to use a custom application to view the data. The system of the present disclosure retains typical recording capabilities and adds the ability to stream data to a remote data repository and remote end user prior to, during, and after an incident. In the vast majority of situations, the information recorded in the data recorder is redundant and not required as data has already been acquired and stored in the remote data repository.

Prior to the system of the present disclosure, data was extracted from the “black box” or “event recorder” after an incident had occurred and an investigation was required. Data files containing time segments recorded by the “black box” had to be downloaded and retrieved from the “black box” and then viewed by a user with proprietary software. The user would have to obtain physical or remote access to the asset, select the desired data to be downloaded from the “black box,” download the file containing the desired information to a computing device, and locate the appropriate file with the desired data using a custom application that operates on the computing device. The system of the present disclosure has eliminated the need for the user to perform these steps, only requiring the user to use a common web browser to navigate to the desired data. The remotely located user may access a common web browser to navigate to desired data relating to a selected asset to view and analyze the operational efficiency and safety of assets in real-time or near real-time.

The remotely located user, such as an asset owner, operator, and/or investigator, may access a common web browser to navigate to live and/or historic desired data relating to a selected asset to view and analyze the operational efficiency and safety of assets in real-time or near real-time. The ability to view operations in real-time, or near real-time, enables rapid evaluation and adjustment of behavior. During an incident, for example, real-time information and/or data can facilitate triaging the situation and provide valuable information to first responders. During normal operation, for example, near real-time information and/or data can be used to audit crew performance and to aid network wide situational awareness.

The real-time data acquisition and recording system of the third embodiment uses at least one of, or any combination of, an image measuring device, a video measuring device, and a range measuring device in, on, or in the vicinity of a mobile asset as part of a data acquisition and recording system. Image measuring devices and/or video measuring devices include, but are not limited to, 360 degrees cameras, fixed cameras, narrow view cameras, wide view cameras, 360 degrees fisheye view cameras, and/or other cameras. Range measuring devices include, but are not limited to, radar and light detection and ranging (“LIDAR”). LIDAR is a surveying method that measures distance to a target by illuminating the target with pulsed laser light and measuring the reflected pulses with a sensor. Prior to the system of the present disclosure, “black box” and/or “event recorders” did not include 360 degrees cameras or other cameras in, on, or in the vicinity of the mobile asset. The system of the present disclosure adds the ability to use and record videos using 360 degrees cameras, fixed cameras, narrow view cameras, wide view cameras, 360 degrees fisheye view cameras, radar, LIDAR, and/or other cameras as part of the data acquisition and recording system, providing 360 degrees views, narrow views, wide views, fisheye views, and/or other views in, on, or in the vicinity of the mobile asset to a remote data repository and a remote user and investigators prior to, during, and after an incident involving the mobile asset has occurred. The ability to view operations, 360 degrees video, and/or other videos in real-time, or near real-time, enables rapid evaluation and adjustment of crew behavior. Owners, operators, and investigators can view and analyze the operational efficiency, safety of people, vehicles, and infrastructures and can investigate or inspect an incident. The ability to view 360 degrees video and/or other videos from the mobile asset enables rapid evaluation and adjustment of crew behavior. During an incident, for example, 360 degrees video and/or other videos can facilitate triaging the situation and provide valuable information to first responders and investigators. During normal operation, for example, 360 degrees video and/or other videos can be used to audit crew performance and to aid network wide situational awareness. The 360 degrees cameras, fixed cameras, narrow view cameras, wide view cameras, 360 degrees fisheye view cameras, radar, LIDAR and/or other cameras provide a complete picture for situations to provide surveillance video for law enforcement and/or rail police, inspection of critical infrastructure, monitoring of railroad crossings, view track work progress, crew auditing both inside the cab and in the yard, and real-time remote surveillance.

Prior systems required users to download video files containing time segments in order to view the video files using a proprietary software application or other external video playback applications. The data acquisition and recording system of the present disclosure provides 360 degrees video, other video, image information and audio information, and range measuring information that can be displayed to a remote user through the use of a virtual reality device and/or through a standard web client, thereby eliminating the need to download and use external applications to watch the videos. Additionally, remotely located users can view 360 degrees videos and/or other videos in various modes through the use of a virtual reality device or through a standard web client, such as a web browser, thereby eliminating the need to download and use external applications to watch the video. Prior video systems required the user to download video files containing time segments of data that were only viewable using proprietary application software or other external video playback applications which the user had to purchase separately.

Data may include, but is not limited to, video and image information from cameras located at various locations in, on or in the vicinity of the asset and audio information from microphones located at various locations in, on or in vicinity of the asset. A 360 degrees camera is a camera that provides a 360 degrees spherical field of view, a 360 degrees hemispherical field of view, and/or 360 degrees fish eye field of view. Using 360 degrees cameras, fixed cameras, narrow view cameras, wide view cameras, 360 degrees fisheye view cameras, and/or other cameras in, on or in the vicinity of an asset provides the ability to use and record video using the 360 degrees cameras, fixed cameras, narrow view cameras, wide view cameras, 360 degrees fisheye view cameras, and/or other cameras as part of DARS, thereby making the 360 degrees view and/or other views in, on or in the vicinity of the asset available to a remote data repository, remotely located users, and investigators prior to, during and after an incident.

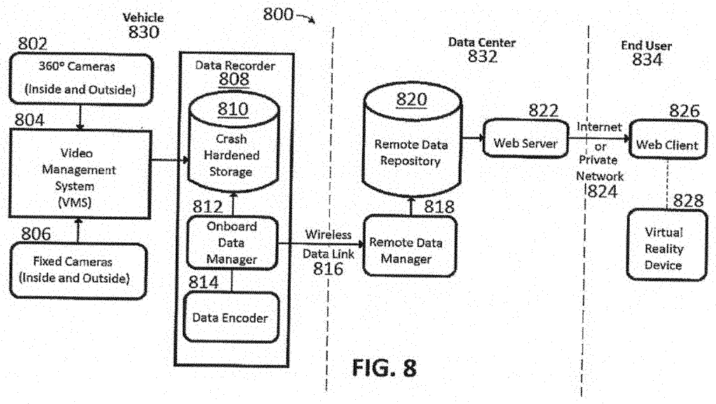

FIG. 8 illustrates a field implementation of the third embodiment of an exemplary real-time data acquisition and recording system (DARS) 800 in which aspects of the disclosure can be implemented. DARS 800 is a system that delivers real time information, video information, and audio information from a data recorder 808 on a mobile asset 830 to remotely located end users via a data center 832. The data recorder 808 is installed on the vehicle or mobile asset 830 and communicates with any number of various information sources through any combination of wired and/or wireless data links such as a wireless gateway/router (not shown). The data recorder 808 comprises a crash hardened memory module 810, an onboard data manager 812, and a data encoder 814. In a fourth embodiment, the data recorder 808 can also include a non-crash hardened removable storage device (not shown). An exemplary hardened memory module 810 can be, for example, a crashworthy event recorder memory module that complies with the Code of Federal Regulations and/or the Federal Railroad Administration regulations, a crash survivable memory unit that complies with the Code of Federal Regulations and/or the Federal Aviation Administration regulations, a crash hardened memory module in compliance with any applicable Code of Federal Regulations, or any other suitable hardened memory device as is known in the art. The wired and/or wireless data links can include any one of or combination of discrete signal inputs, standard or proprietary Ethernet, serial connections, and wireless connections.

Data recorder 808 gathers video data, audio data, and other data and/or information from a wide variety of sources, which can vary based on the asset's configuration, through onboard data links. In this implementation, data recorder 808 receives data from a video management system 804 that continuously records video data and audio data from 360 degrees cameras, fixed cameras, narrow view cameras, wide view cameras, 360 degrees fisheye view cameras, radar, LIDAR, and/or other cameras 802 and fixed cameras 806 that are placed in, on or in the vicinity of the asset 830 and the video management system 804 stores the video and audio data to the crash hardened memory module 810, and can also store the video and audio data in the non-crash hardened removable storage device of the fourth embodiment. Different versions of the video data are created using different bitrates or spatial resolutions and these versions are separated into segments of variable length, such as thumbnails, five minute low resolution segments, and five minute high resolution segments.

The data encoder 814 encodes at least a minimum set of data that is typically defined by a regulatory agency. The data encoder 814 receives video and audio data from the video management system 804 and compresses or encodes the data and time synchronizes the data in order to facilitate efficient real-time transmission and replication to a remote data repository 820. The data encoder 814 transmits the encoded data to the onboard data manager 812 which then sends the encoded video and audio data to the remote data repository 820 via a remote data manager 818 located in the data center 830 in response to an on-demand request by a remotely located user 834 or in response to certain operating conditions being observed onboard the asset 830. The onboard data manager 812 and the remote data manager 818 work in unison to manage the data replication process. The remote data manager 818 in the data center 832 can manage the replication of data from a plurality of assets. The video and audio data stored in the remote data repository 820 is available to a web server 822 for the remote located user 834 to access.

The onboard data manager 812 also sends data to a queueing repository (not shown). The onboard data manager 812 monitors the video and audio data stored in the crash hardened memory module 810, and/or the optional non-crash hardened removable storage device of the fourth embodiment, by the video management system 804 and determines whether it is in near real-time mode or real-time mode. In near real-time mode, the onboard data manager 812 stores the encoded data, including video data, audio data, and any other data or information, received from the data encoder 814 and any event information in the crash hardened memory module 810, and/or the optional non-crash hardened removable storage device of the fourth embodiment, and in the queueing repository. After five minutes of encoded data has accumulated in the queueing repository, the onboard data manager 812 stores the five minutes of encoded data to the remote data repository 820 via the remote data manager 818 in the data center 832 through a wireless data link 816. In real-time mode, the onboard data manager 812 stores the encoded data, including video data, audio data, and any other data or information, received from the data encoder 814 and any event information to the remote data repository 820 via the remote data manager 818 in the data center 832 through the wireless data link 816 every configurable predetermined time period, such as every second or every 0.10 seconds. The onboard data manager 812 and the remote data manager 818 can communicate over a variety of wireless communications links. Wireless data link 816 can be, for example, a wireless local area network (WLAN), wireless metropolitan area network (WMAN), wireless wide area network (WWAN), a private wireless system, a cellular telephone network or any other means of transferring data from the data recorder 808 to, in this example, the remote data manager 818. The process of sending and retrieving video data and audio data remotely from the asset 830 requires a wireless data connection between the asset 830 and the data center 832. When a wireless data connection is not available, the data is stored and queued in the crash hardened memory module 810, and/or the optional non-crash hardened removable storage device of the fourth embodiment, until wireless connectivity is restored. The video, audio, and any other additional data retrieval process resumes as soon as wireless connectivity is restored.

In parallel with data recording, the data recorder 808 continuously and autonomously replicates data to the remote data repository 820. The replication process has two modes, a real-time mode and a near real-time mode. In real-time mode, the data is replicated to the remote data repository 820 every second. In near real-time mode, the data is replicated to the remote data repository 820 every five minutes. The rates used for near real-time mode and real-time mode are configurable and the rate used for real-time mode can be adjusted to support high resolution data by replicating data to the remote data repository 820 every 0.10 seconds. Near real-time mode is used during normal operation, under most conditions, in order to improve the efficiency of the data replication process.

Real-time mode can be initiated based on events occurring onboard the asset 830 or by a request initiated from the data center 832. A typical data center 832 initiated request for real-time mode is initiated when the remotely located user 834 has requested real-time information from a web client 826. A typical reason for real-time mode to originate onboard the asset 830 is the detection of an event or incident such as an operator initiating an emergency stop request, emergency braking activity, rapid acceleration or deceleration in any axis, or loss of input power to the data recorder 808. When transitioning from near real-time mode to real-time mode, all data not yet replicated to the remote data repository 820 is replicated and stored in the remote data repository 820 and then live replication is initiated. The transition between near real-time mode and real-time mode typically occurs in less than five seconds. After a predetermined amount of time has passed since the event or incident, a predetermined amount of time of inactivity, or when the user 834 no longer desires real-time information from the asset 830, the data recorder 808 reverts to near real-time mode. The predetermined amount of time required to initiate the transition is configurable and is typically set to ten minutes.

When the data recorder 808 is in real-time mode, the onboard data manager 812 attempts to continuously empty its queue to the remote data manager 818, storing the data to the crash hardened memory module 810, and the optional non-crash hardened removable storage device of the fourth embodiment, and sending the data to the remote data manager 818 simultaneously.

Upon receiving video data, audio data, and any other data or information to be replicated from the data recorder 808, the remote data manager 818 stores the data to the remote data repository 820 in the data center 830. The remote data repository 820 can be, for example, cloud-based data storage or any other suitable remote data storage. When data is received, a process is initiated that causes a data decoder (not shown) to decode the recently replicated data from the remote data repository 820 and send the decoded data to a remote event detector (not shown). The remote data manager 818 stores vehicle event information in the remote data repository 820. When the remote event detector receives the decoded data, it processes the decoded data to determine if an event of interest is found in the decoded data. The decoded information is then used by the remote event detector to detect events, incidents, or other predefined situations, in the data occurring with the asset 830. Upon detecting an event of interest from the decoded data previously stored in the remote data repository 820, the remote event detector stores the event information and supporting data in the remote data repository 820.

Video data, audio data, and any other data or information is available to the user 834 in response to an on-demand request by the user 834 and/or is sent by the onboard data manager 812 to the remote data repository 820 in response to certain operating conditions being observed onboard the asset 830. Video data, audio data, and any other data or information stored in the remote data repository 820 is available on the web server 822 for the user 834 to access. The remotely located user 834 can access the video data, audio data, and any other data or information relating to the specific asset 830, or a plurality of assets, stored in the remote data repository 820 using the standard web client 826, such as a web browser, or a virtual reality device 828 which, in this implementation, can display thumbnail images of selected cameras. The web client 826 communicates the user's 834 request for video, audio, and/or other information to the web server 822 through a network 824 using common web standards protocols, and techniques. Network 824 can be, for example, the Internet. Network 824 can also be a local area network (LAN), metropolitan area network (MAN), wide area network (WAN), virtual private network (VPN), a cellular telephone network or any other means of transferring data from the web server 822 to, in this example, the web client 826. The web server 822 requests the desired data from the remote data repository 820. The web server 822 then sends the requested data to the web client 826 that provides playback and real-time display of standard video, 360 degrees video, and/or other video. The web client 826 plays the video data, audio data, and any other data or information for the user 834 who can interact with the 360 degrees video data and/or other video data and/or still image data for viewing and analysis. The user 834 can also download the video data, audio data, and any other data or information using the web client 826 and can then use the virtual reality device 828 to interact with the 360 degrees video data for viewing and analysis.

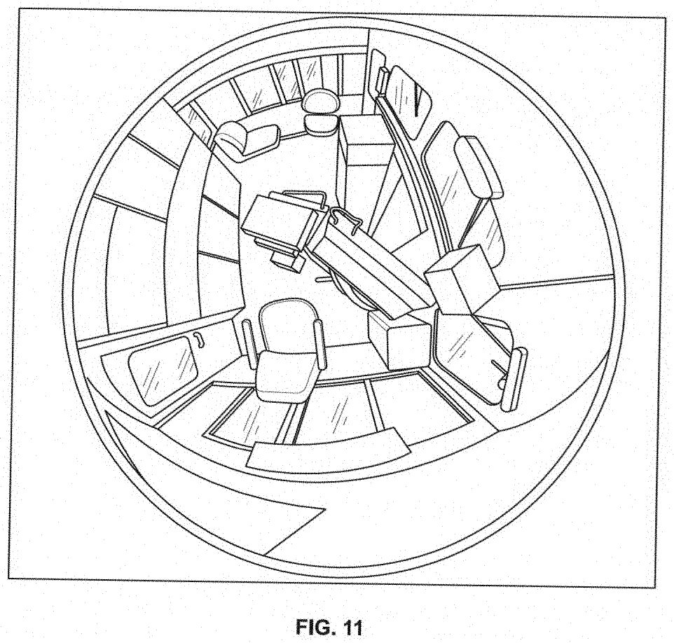

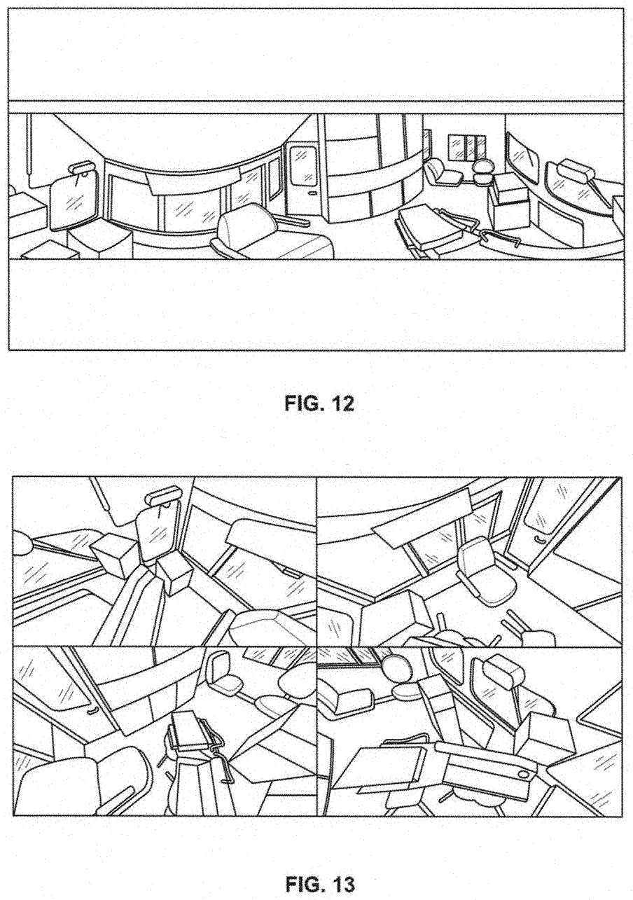

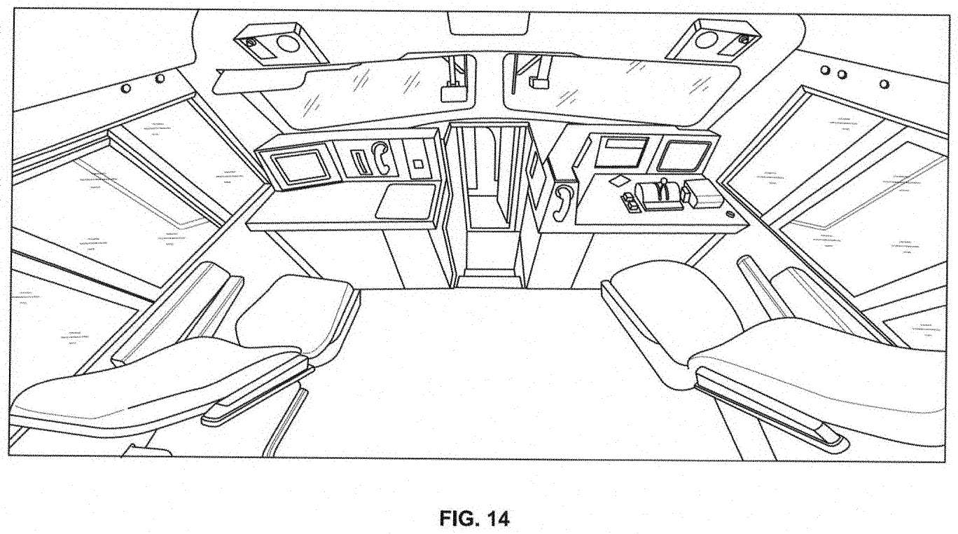

The web client 826 can be enhanced with a software application that provides the playback of 360 degrees video and/or other video in a variety of different modes. The user 834 can elect the mode in which the software application presents the video playback such as, for example, fisheye view as shown in FIG. 11, panorama view as shown in FIG. 12, double panorama view (not shown), quad view as shown in FIG. 13, and dewarped view as shown in FIG. 14.

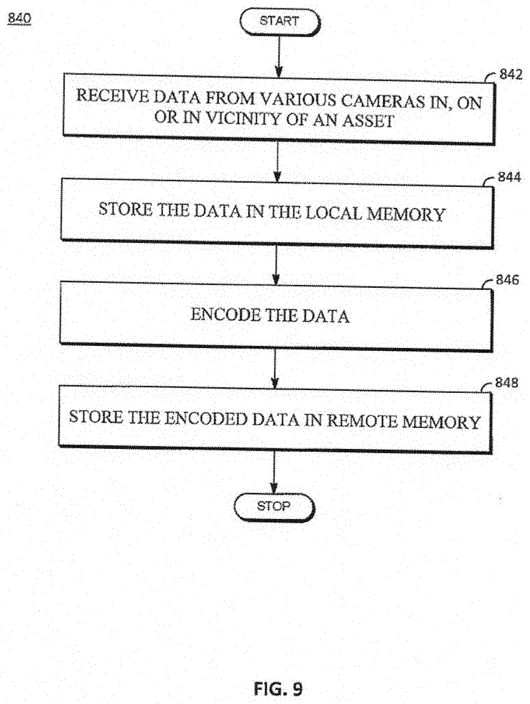

FIG. 9 is a flow diagram showing a process 840 for recording video data, audio data, and/or information from the asset 830 in accordance with an implementation of this disclosure. Video management system 804 receives data signals from various input components 842, such as the 360 degrees cameras, fixed cameras, narrow view cameras, wide view cameras, 360 degrees fisheye view cameras, radar, LIDAR and/or other cameras 802 and the fixed cameras 806 on, in or in the vicinity of the asset 830. The video management system 804 then stores the video data, audio data, and/or information in the crash hardened memory module 810, and/or the optional non-crash hardened removable storage device of the fourth embodiment, 844 using any combination of industry standard formats, such as, for example, still images, thumbnails, still image sequences, or compressed video formats. Data encoder 814 creates a record that includes a structured series of bits used to configure and record the data signal information 846. In near real-time mode, the video management system 804 stores video data into the crash hardened memory module 810, and/or the optional non-crash hardened removable storage device of the fourth embodiment, while only sending limited video data, such as thumbnails or very short low resolution video segments, off board to the remote data repository 820 848.

In another implementation, the encoded record is then sent to the onboard data manager 812 that sequentially combines a series of records in chronological order into record blocks that include up to five minutes of data. An interim record block includes less than five minutes of data while a full record block includes a full five minutes of data. Each record block includes all the data required to fully decode the included signals, including a data integrity check. At a minimum, a record block must start with a start record and end with an end record.

In order to ensure that all of the encoded signal data is saved to the crash hardened memory module 810, and/or the optional non-crash hardened removable storage device of the fourth embodiment, should the data recorder 808 lose power, the onboard data manager 812 stores interim record blocks in the crash hardened memory module 810, and/or the optional non-crash hardened removable storage device of the fourth embodiment, at a predetermined rate, where the predetermined rate is configurable and/or variable. Interim record blocks are saved at least once per second but can also be saved as frequently as once every tenth of a second. The rate at which interim record blocks are saved depends on the sampling rates of each signal. Every interim record block includes the full set of records since the last full record block. The data recorder 808 can alternate between two temporary storage locations in the crash hardened memory module 810 when recording each interim record block to prevent the corruption or loss of more than one second of data when the data recorder 808 loses power while storing data to the crash hardened memory module 810. Each time a new interim record block is saved to a temporary crash hardened memory location it will overwrite the existing previously stored interim record block in that location.

Every five minutes, in this implementation, when the data recorder 808 is in near real-time mode, the onboard data manager 812 stores a full record block including the last five minutes of encoded signal data into a record segment in the crash hardened memory module 810, and/or the optional non-crash hardened removable storage device of the fourth embodiment, and sends a copy of the full record block, comprising five minutes of video data, audio data, and/or information, to the remote data manager 818 to be stored in the remote data repository 820 for a predetermined retention period such as two years. The crash hardened memory module 810, and/or the optional non-crash hardened removable storage device of the fourth embodiment, stores a record segment of the most recent record blocks for a mandated storage duration, which in this implementation is the federally mandated duration that the data recorder 808 must store operational or video data in the crash hardened memory module 810 with an additional 24 hour buffer, and is then overwritten.

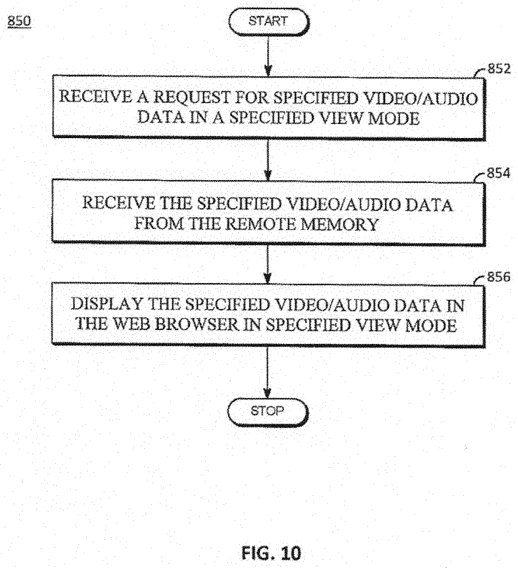

FIG. 10 is a flow diagram showing a process 850 for viewing data and/or information from the asset 830 through a web browser 826 or virtual reality device 828. When an event occurs or when the remotely located authorized user 834 requests a segment of video data stored in the crash hardened memory module 810 via the web client 826, the onboard data manager 812, depending on the event, will begin sending video data off board in real-time at the best resolution available given the bandwidth of the wireless data link 816. The remotely located user 834 initiates a request for specific video and/or audio data in a specific view mode 852 through the web client 826 which communicates the request to the web server 822 through network 824. The web server 822 requests the specific video and/or audio data from the remote data repository 820 and sends the requested video and/or audio data to the web client 826 854 through the network 824. The web client 826 displays the video and/or audio data in the view mode specified by the user 834 856. The user 834 can then download the specific video and/or audio data to view on the virtual reality device 828. In another implementation, in real-time mode, thumbnails are sent first at one second intervals, then short segments of lower resolution videos, and then short segments of higher resolution videos.

For simplicity of explanation, process 840 and process 850 are depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

A fifth embodiment of a real-time data acquisition and recording system and video analytics system described herein provides real-time, or near real-time, access to a wide range of data, such as event and operational data, video data, and audio data, of a high value asset to remotely located users. The data acquisition and recording system records data relating to the asset and streams the data to a remote data repository and remotely located users prior to, during, and after an incident has occurred. The data is streamed to the remote data repository in real-time, or near real-time, making information available at least up to the time of an incident or emergency situation, thereby virtually eliminating the need to locate and download the “black box” in order to investigate an incident involving the asset by streaming information to the remote data repository in real-time, or near real-time, and making information available at least up to the time of a catastrophic event. DARS performs video analysis of video data recorded of the mobile asset to determine, for example, cab occupancy, track detection, and detection of objects near tracks. The remotely located user may use a common web browser to navigate to and view desired data relating to a selected asset and is not required to interact with the data acquisition and recording system on the asset to request a download of specific data, to locate or transfer files, and to use a custom application to view the data.

DARS provides remotely located users access to video data and video analysis performed by a video analytics system by streaming the data to the remote data repository and to the remotely located user prior to, during, and after an incident, thereby eliminating the need for a user to manually download, extract, and playback video to review the video data to determine cab occupancy, whether a crew member or unauthorized personnel was present during an incident, track detection, detection of objects near tracks, investigation or at any other time of interest. Additionally, the video analytics system provides cab occupancy status determination, track detection, detection of objects near tracks, lead and trail unit determination by processing image and video data in real-time, thereby ensuring that the correct data is always available to the user. For example, the real-time image processing ensures that a locomotive designated as the trail locomotive is not in lead service to enhance railroad safety. Prior systems provided a locomotive position within the train by using the train make-up functionality in dispatch systems. At times, the dispatch system information can be obsolete as the information is not updated in real-time and crew personnel can change the locomotive if deemed necessary.

Prior to the system of the present disclosure, inspection crews and/or asset personnel had to manually inspect track conditions, manually check if the vehicle is in the lead or trail position, manually survey the locations of each individual object of interest, manually create a database of geographic locations of all objects of interest, periodically performs manual field surveys of each object of interest to verify their location and identify any changes in geographic location that differs from the original survey, manually update the database when objects of interest change location due to repair or additional infrastructure development since the time when the original database was created, select and download desired data from a digital video recorder and/or data recorder and inspect the downloaded data and/or video offline and check tracks for any obstructions, and the vehicle operator had to physically check for any obstructions and/or switch changes. The system of the present disclosure has eliminated the need for users to perform these steps, only requiring the user to use a common web browser to navigate to the desired data. Asset owners and operators can automate and improve the efficiency and safety of mobile assets in real-time and can actively monitor the track conditions and can get warning information in real-time. The system of the present disclosure eliminates the need for asset owners and operators to download data from the data recorder in order to monitor track conditions and investigate incidents. As an active safety system, DARS can aid the operator to check for any obstructions, send alerts in real-time and/or save the information offline, and send alert information for remote monitoring and storage. Both current and past track detection information and/or information relating to detection of objects near tracks can be stored in the remote data repository in real-time to aid the user in viewing the information when required. The remotely located user may access a common web browser to navigate to desired data relating to a selected asset to view and analyze the operational efficiency and safety of assets in real-time or near real-time.

The real-time data acquisition and recording system of the fifth embodiment can be used to continuously monitor objects of interest and identify in real-time when they have been moved or damaged, become obstructed by foliage, and/or are in disrepair and in need of maintenance. DARS utilizes video, image, and/or audio information to detect and identify various infrastructure objects, such as rail tracks, in the videos, has the ability to follow the tracks as the mobile asset progresses, and has the ability to create, audit against and periodically update a database of objects of interest with the geographical location. The real-time data acquisition and recording system of the fifth embodiment uses at least one of, or any combination of, an image measuring device, a video measuring device, and a range measuring device in, on, or in the vicinity of a mobile asset as part of a data acquisition and recording system. Image measuring devices and/or video measuring devices include, but are not limited to, 360 degrees cameras, fixed cameras, narrow view cameras, wide view cameras, 360 degrees fisheye view cameras, and/or other cameras. Range measuring devices include, but are not limited to, radar and light detection and ranging (“LIDAR”). LIDAR is a surveying method that measures distance to a target by illuminating the target with pulsed laser light and measuring the reflected pulses with a sensor.

DARS can automatically inspect track conditions, such as counting the number of tracks present, identifying the current track the mobile asset is traveling on, and detecting any obstructions or defects present, such as ballast washed out, broken tracks, tracks out of gauge, misaligned switches, switch run-overs, flooding in the tracks, snow accumulations, etc., and plan for any preventive maintenance so as to avoid any catastrophic events. DARS can also detect rail track switches and follow track changes. DARS can further detect the change in the location of data including whether an object is missing, obstructed and/or not present at the expected location. Track detection, infrastructure diagnosing information, and/or infrastructure monitoring information can be displayed to a user through the use of any standard web client, such as a web browser, thereby eliminating the need to download files from the data recorder and use proprietary application software or other external applications to view the information as prior systems required. This process can be extended to automatically create, audit, and/or update a database with geographic locations of objects of interest and to ensure compliance with Federal Regulations. With the system of the present disclosure, cameras previously installed to comply with Federal Regulations are utilized to perform various tasks that previously required human interaction, specialized vehicles, and/or alternate equipment. DARS allows these tasks to be performed automatically as the mobile asset travels throughout the territory as part of normal revenue service and daily operation. DARS can be used to save countless person-hours of manual work by utilizing normal operations of vehicles and previously installed cameras to accomplish tasks which previously required manual effort. DARS can also perform tasks which previously have been performed using specialized vehicles, preventing closure of segments of track to inspect and locate track and objects of interest which often resulted in loss of revenue service and expensive equipment to purchase and maintain. DARS further reduces the amount of time humans are required to be located within the near vicinity of rail tracks, resulting in less overall accidents and potential loss of life.

Data may include, but is not limited to, measured analog and frequency parameters such as speed, pressure, temperature, current, voltage and acceleration that originates from the mobile assets and/or nearby mobile assets; measured Boolean data such as switch positions, actuator positions, warning light illumination, and actuator commands; position, speed and altitude information from a global positioning system (GPS) and additional data from a geographic information system (GIS) such as the latitude and longitude of various objects of interest; internally generated information such as the regulatory speed limit for the mobile asset given its current position; train control status and operational data generated by systems such as positive train control (PTC); vehicle and inertial parameters such as speed, acceleration, and location such as those received from the GPS; GIS data such as the latitude and longitude of various objects of interest; video and image information from at least one camera located at various locations in, on, or in the vicinity of the mobile asset; audio information from at least one microphone located at various locations in, on, or in the vicinity of the mobile asset; information about the operational plan for the mobile asset that is sent to the mobile asset from a data center such as route, schedule, and cargo manifest information; information about the environmental conditions, such as current and forecasted weather, of the area in which the mobile asset is currently operating in or is planned to operate in; and data derived from a combination of any of the above sources including additional data, video, and audio analysis and analytics.

“Track” may include, but is not limited to, the rails and ties of the railroads used for locomotive and/or train transportation. “Objects of interest” may include, but are not limited to, various objects of infrastructure installed and maintained within the nearby vicinity of railroad tracks which may be identified with the use of artificial intelligence, such as supervised learning or reinforcement learning, of asset camera images and video. Supervised learning and/or reinforcement learning utilizes previously labeled data sets defined as “training” data to allow remote and autonomous identification of objects within view of the camera in, on, or in the vicinity of the mobile asset. Supervised learning and/or reinforcement learning trains the neural network models to identify patterns occurring within the visual imagery obtained from the cameras. These patterns, such as people, crossing gates, cars, trees, signals, switches, etc., can be found in single images alone. Successive frames within a video can also be analyzed for patterns such as blinking signals, moving cars, people falling asleep, etc. DARS may or may not require human interaction at any stage of implementation including, but not limited to, labeling training data sets required for supervised learning and/or reinforcement learning. Objects of interest include, but are not limited to, tracks, track centerline points, milepost signs, signals, crossing gates, switches, crossings, and text based signs. “Video analytics” refers to any intelligible information gathered by analyzing videos and/or images recorded from the image measuring devices, video measuring devices, and/or range measuring devices, such as at least one camera, such as 360 degrees cameras, fixed cameras, narrow view cameras, wide view cameras, 360 degrees fisheye view cameras, radar, LIDAR, and/or other cameras, in, on, or in the vicinity of the mobile asset, such as, but not limited to, objects of interest, geographic locations of objects, track obstructions, distances between objects of interest and the mobile asset, track misalignment, etc. The video analytics system can also be used in any mobile asset, dwelling area, space, or room containing a surveillance camera to enhance video surveillance. In mobile assets, the video analytics system provides autonomous cab occupied event detection to remotely located users economically and efficiently.

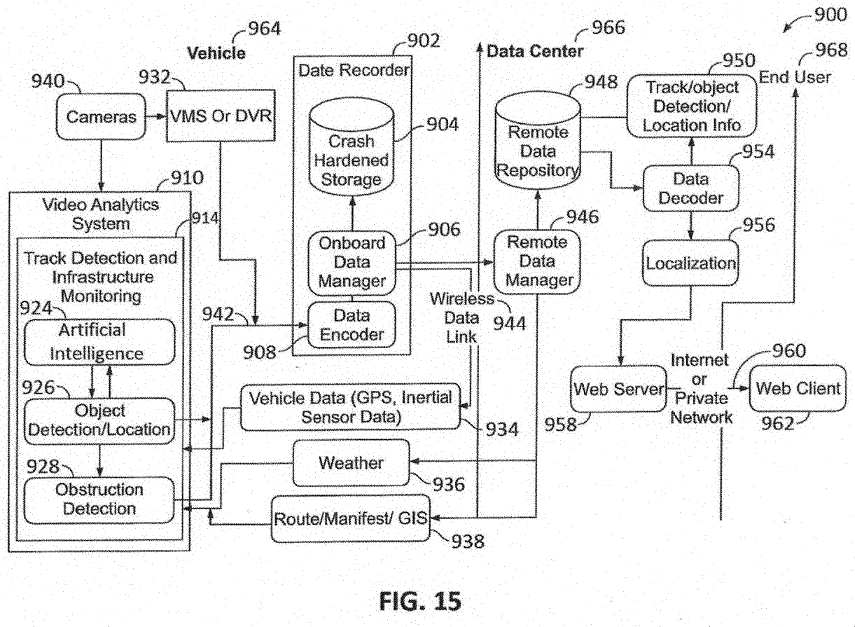

FIG. 15 illustrates a field implementation of the fifth embodiment of an exemplary real-time data acquisition and recording system (DARS) 900 in which aspects of the disclosure can be implemented. DARS 900 is a system that delivers real time information, video information, and audio information from a data recorder 902 on a mobile asset 964 to remotely located end users 968 via a data center 966. The data recorder 902 is installed on the vehicle or mobile asset 964 and communicates with any number of various information sources through any combination of wired and/or wireless data links 942, such as a wireless gateway/router (not shown). Data recorder 902 gathers video data, audio data, and other data or information from a wide variety of sources, which can vary based on the asset's configuration, through onboard data links 942. The data recorder 902 comprises a local memory component, such as a crash hardened memory module 904, an onboard data manager 906, and a data encoder 908 in the asset 964. In a sixth embodiment, the data recorder 902 can also include a non-crash hardened removable storage device (not shown). An exemplary hardened memory module 904 can be, for example, a crashworthy event recorder memory module that complies with the Code of Federal Regulations and/or the Federal Railroad Administration regulations, a crash survivable memory unit that complies with the Code of Federal Regulations and/or the Federal Aviation Association regulations, a crash hardened memory module in compliance with any applicable Code of Federal Regulations, or any other suitable hardened memory device as is known in the art. The wired and/or wireless data links can include any one of or combination of discrete signal inputs, standard or proprietary Ethernet, serial connections, and wireless connections.

DARS 900 further comprises a video analytics system 910 that includes a track and/or object detection and infrastructure monitoring component 914. The track detection and infrastructure monitoring component 914 comprises an artificial intelligence component 924, such as a supervised learning and/or reinforcement learning component, or other neural network or artificial intelligence component, an object detection and location component 926, and an obstruction detection component 928 that detects obstructions present on or near the tracks and/or camera obstructions such as personnel blocking the cameras view. In this implementation, live video data is captured by at least one camera 940 mounted in the cab of the asset 964, on the asset 964, or in the vicinity of the asset 964. The cameras 940 are placed at an appropriate height and angle to capture video data in and around the asset 964 and obtain a sufficient amount of the view for further processing. The live video data and image data is captured in front of and/or around the asset 964 by the cameras 940 and is fed to the track and/or object detection and infrastructure monitoring component 914 for analysis. The track detection and infrastructure monitoring component 914 of the video analytics system 910 processes the live video and image data frame by frame to detect the presence of the rail tracks and any objects of interest. Camera position parameters such as height, angle, shift, focal length, and field of view can either be fed to the track and/or object detection and infrastructure monitoring component 914 or the cameras 940 can be configured to allow the video analytics system 910 to detect and determine the camera position and parameters.

To make a status determination, such as cab occupancy detection, the video analytics system 910 uses the supervised learning and/or reinforcement learning component 924, and/or other artificial intelligence and learning algorithms, to evaluate, for example, video data from cameras 940, asset data 934 such as speed, GPS data, and inertial sensor data, weather component 936 data, and route/crew manifest, and GIS component data 938. Cab occupancy detection is inherently susceptible to environmental noise sources such as light reflecting off clouds and sunlight passing through buildings and trees while the asset is moving. To handle environmental noise, the supervised learning and/or reinforcement learning component 924, the object detection and location component 926, the obstruction detection component, asset component 934 data that can include speed, GPS data, and inertial sensor data, weather component 936 data, and other learning algorithms are composed together to form internal and/or external status determinations involving the mobile asset 964. The track and/or object detection and infrastructure monitoring component 914 can also include a facial recognition system adapted to allow authorizing access to a locomotive as part of a locomotive security system, a fatigue detection component adapted to monitor crew alertness, and activity detection component to detect unauthorized activities such as smoking.

Additionally, the video analytics system 910 may receive location information, including latitude and longitude coordinates, of a signal, such as a stop signal, traffic signal, speed limit signal, and/or object signal near the tracks, from the asset owner. The video analytics system 910 then determines whether the location information received from the asset owner is correct. If the location information is correct, the video analytics system 910 stores the information and will not recheck the location information again for a predetermined amount of time, such as checking the location information on a monthly basis. If the location information is not correct, the video analytics system 910 determines the correct location information and reports the correct location information to the asset owners, stores the location information, and will not recheck the location information again for a predetermined amount of time, such as checking the location information on a monthly basis. Storing the location information provides easier detection of a signal, such as a stop signal, traffic signal, speed limit signal, and/or object signals near the tracks.

Artificial intelligence, such as supervised learning and/or reinforcement learning, using the artificial intelligence component 924, of the tracks is performed by making use of various information obtained from consecutive frames of video and/or images and also using additional information received from the data center 966 and a vehicle data component 934 that includes inertial sensor data and GPS data to determine learned data. The object detection and location component 926 utilizes the learned data received from the supervised learning and/or reinforcement learning component 924 and specific information about the mobile asset 964 and railroad such as track width and curvatures, ties positioning, and vehicle speed to differentiate the rail tracks, signs, signals, etc. from other objects to determine object detection data. The obstruction detection component 928 utilizes the object detection data received from the object detection and location component 926, such as information on obstructions present on or near the tracks and/or camera obstructions such as personnel blocking the cameras view and additional information from a weather component 936, a route/crew manifest data and GIS data component 938, and the vehicle data component 934 that includes inertial sensor data and GPS data to enhance accuracy and determine obstruction detection data. Mobile asset data from the vehicle data component 934 includes, but is not limited to, speed, location, acceleration, yaw/pitch rate, and rail crossings. Any additional information received and utilized from the data center 966 includes, but is not limited to, day and night details and geographic position of the mobile asset 964.

Infrastructure objects of interest, information processed by the track and/or object detection and infrastructure monitoring component 914, and diagnosis and monitoring information is sent to the data encoder 908 of the data recorder 902 via onboard data links 942 to encode the data. The data recorder 902 stores the encoded data in the crash hardened memory module 904, and optionally in the optional non-crash hardened removable storage device of the sixth embodiment, and sends the encoded information to a remote data manager 946 in the data center 966 via a wireless data link 944. The remote data manager 946 stores the encoded data in a remote data repository 948 in the data center 966.

To determine obstruction detection 928 or object detection 926, such as the presence of track in front of the asset, objects on and/or near the tracks, obstructions on or near the tracks, and/or obstructions blocking the cameras view, 964, the vehicle analytics system 910 uses the supervised learning and/or reinforcement learning component 924, or other artificial intelligence, object detection and location component 926, and obstruction detection component 928, and other image processing algorithms to process and evaluate camera images and video data from cameras 940 in real-time. The track and/or object detection and infrastructure monitoring component 914 uses the processed video data along with asset component 934 data that can include speed, GPS data, and inertial sensor data, weather component 936 data, and route/crew, manifest, and GIS component 938 data, to determine the external status determinations, such as lead and trail mobile assets, in real-time. When processing image and video data for track and/or object detection, for example, the video analytics system 910 automatically configures cameras 940 parameters needed for track detection, detects run through switches, counts the number of tracks, detects any additional tracks along the side of the asset 964, determines the track on which the asset 964 is currently running, detects the track geometry defects, detects track washout scenarios such as detecting water near the track within defined limits of the tracks, and detects missing slope or track scenarios. Object detection accuracy depends on the existing lighting condition in and around the asset 964. DARS 900 will handle the different lighting conditions with the aid of additional data collected from onboard the asset 964 and the data center 966. DARS 900 is enhanced to work in various lighting conditions, to work in various weather conditions, to detect more objects of interest, to integrate with existing database systems to create, audit, and update data automatically, to detect multiple tracks, to work consistently with curved tracks, to detect any obstructions, to detect any track defect that could possibly cause safety issues, and to work in low cost embedded systems.

The internal and/or external status determination from the video analytics system 910, such as cab occupancy; object detection and location such as track detection and detection of objects near tracks; and obstruction detection such as obstructions on or near the tracks and obstructions blocking the cameras, is provided to the data recorder 902, along with any data from a vehicle management system (VMS) or digital video recorder component 932, via onboard data links 942. The data recorder 902 stores the internal and/or external status determination, the object detection and location component 926 data, and the obstruction detection component 928 data in the crash hardened memory module 904, and optionally in the non-crash hardened removable storage device of the sixth embodiment, and the remote data repository 948 via the remote data manager 946 located in the data center 966. A web server 958 provides the internal and/or external status determination, the object detection and location component 926 information, and the obstruction detection component 928 information to a remotely located user 968 via a web client 962 upon request.

The data encoder 908 encodes at least a minimum set of data that is typically defined by a regulatory agency. The data encoder 908 receives video, image and audio data from any of the cameras 940, the video analytics system 910, and the video management system 932 and compresses or encodes and time synchronizes the data in order to facilitate efficient real-time transmission and replication to the remote data repository 948. The data encoder 908 transmits the encoded data to the onboard data manager 906 which then sends the encoded video, image, and audio data to the remote data repository 948 via the remote data manager 946 located in the data center 966 in response to an on-demand request by the user 968 or in response to certain operating conditions being observed onboard the asset 964. The onboard data manager 906 and the remote data manager 946 work in unison to manage the data replication process. The remote data manager 946 in the data center 966 can manage the replication of data from a plurality of assets 964.

The onboard data manager 908 determines if the event detected, the internal and/or external status determination, object detection and location, and/or obstruction detection, should be queued or sent off immediately based on prioritization of the event detected. For example, in a normal operating situation, detecting an obstruction on the track is much more urgent than detecting whether someone is in the cab of the asset 964. The onboard data manager 908 also sends data to the queuing repository (not shown). In near real-time mode, the onboard data manager 988 stores the encoded data received from the data encoder 908 and any event information in the crash hardened memory module 904 and in the queueing repository. After five minutes of encoded data has accumulated in the queuing repository, the onboard data manager 906 stores the five minutes of encoded data to a remote data repository 948 via the remote data manager 946 in the data center 966 over the wireless data link 944. In real-time mode, the onboard data manager 908 stores the encoded data received from the data encoder 908 and any event information to the crash hardened memory module 904 and to the remote data repository 948 via the remote data manager 946 in the data center 966 over the wireless data link 944 every configurable predetermined time period, such as every second or every 0.10 seconds.

In this implementation, the onboard data manager 906 sends the video data, audio data, internal and/or external status determination, object detection and location information, obstruction detection information, and any other data or event information to the remote data repository 948 via the remote data manager 946 in the data center 966 through the wireless data link 944. Wireless data link 944 can be, for example, a wireless local area network (WLAN), wireless metropolitan area network (WMAN), wireless wide area network (WWAN), wireless virtual private network (WVPN), a cellular telephone network or any other means of transferring data from the data recorder 902 to, in this example, the remote data manager 946. The process of retrieving the data remotely from the asset 964 requires a wireless connection between the asset 964 and the data center 966. When a wireless data connection is not available, the data is stored and queued until wireless connectivity is restored.

In parallel with data recording, the data recorder 902 continuously and autonomously replicates data to the remote data repository 948. The replication process has two modes, a real-time mode and a near real-time mode. In real-time mode, the data is replicated to the remote data repository 10 every second. In near real-time mode, the data is replicated to the remote data repository 15 every five minutes. The rates used for near real-time mode and real-time mode are configurable and the rate used for real-time mode can be adjusted to support high resolution data by replicating data to the remote data repository 15 every 0.10 seconds. Near real-time mode is used during normal operation, under most conditions, in order to improve the efficiency of the data replication process.

Real-time mode can be initiated based on events occurring onboard the asset 964 or by a request initiated from the data center 966. A typical data center 966 initiated request for real-time mode is initiated when the remotely located user 968 has requested real-time information from the web client 962. A typical reason for real-time mode to originate onboard the asset 964 is the detection of an event or incident involving the asset 964, such as an operator initiating an emergency stop request, emergency braking activity, rapid acceleration or deceleration in any axis, or loss of input power to the data recorder 902. When transitioning from near real-time mode to real-time mode, all data not yet replicated to the remote data repository 948 is replicated and stored in the remote data repository 948 and then live replication is initiated. The transition between near real-time mode and real-time mode typically occurs in less than five seconds. After a predetermined amount of time has passed since the event or incident, predetermined amount of time of inactivity, or when the user 968 no longer desires real-time information from the asset 964, the data recorder 902 reverts to near real-time mode. The predetermined amount of time required to initiate the transition is configurable and is typically set to ten minutes.

When the data recorder 902 is in real-time mode, the onboard data manager 906 attempts to continuously empty its queue to the remote data manager 946, storing the data to the crash hardened memory module 940, and optionally to the optional non-crash hardened removable storage device of the sixth embodiment, and sending the data to the remote data manager 946 simultaneously.

Upon receiving video data, audio data, internal and/or external status determination, object detection and location information, obstruction detection information, and any other data or information to be replicated from the data recorder 902, the remote data manager 946 stores the data it receives from the onboard data manager 906, such as encoded data and detected event data, to the remote data repository 948 in the data center 966. The remote data repository 948 can be, for example, cloud-based data storage or any other suitable remote data storage. When data is received, a process is initiated that causes a data decoder 954 to decode the recently replicated data from the remote data repository 948 and send the decoded data to a track/object detection/location information component 950 that looks at the stored data for additional ‘post-processed’events. The track/object detection/location information component 950 includes an object/obstruction detection component for determining internal and/or external status determinations, object detection and location information, and obstruction detection information, in this implementation. Upon detecting internal and/or external information, object detection and location information, and/or obstruction detection information, the track/object detection/location information component 950 stores the information in the remote data repository 948.

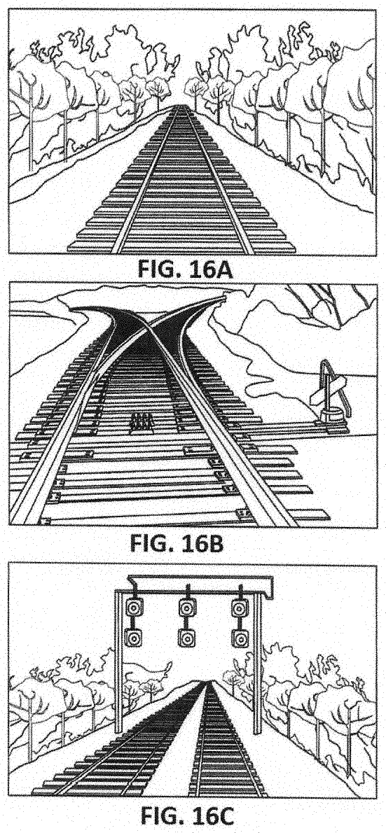

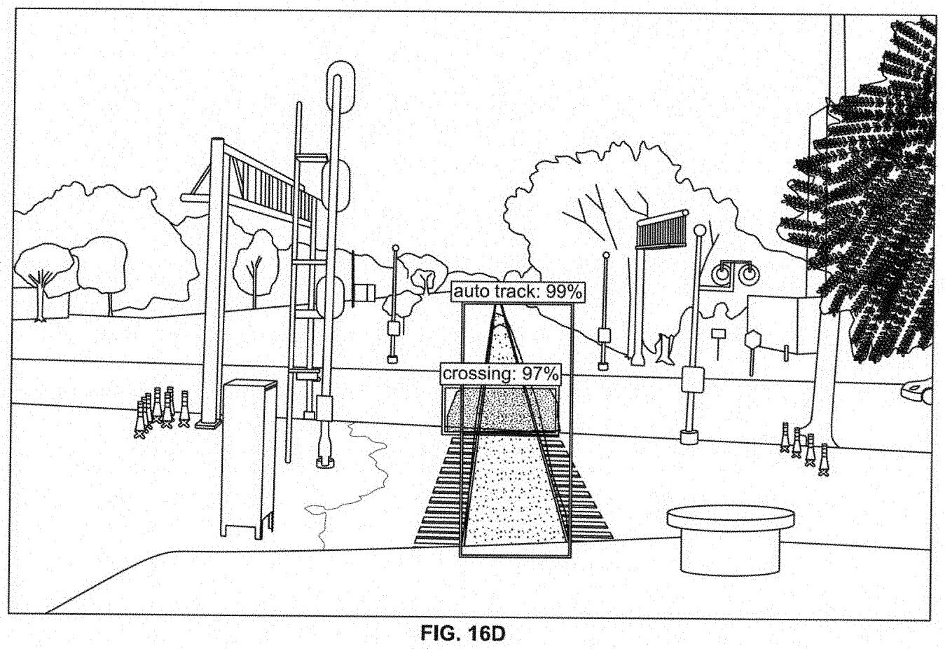

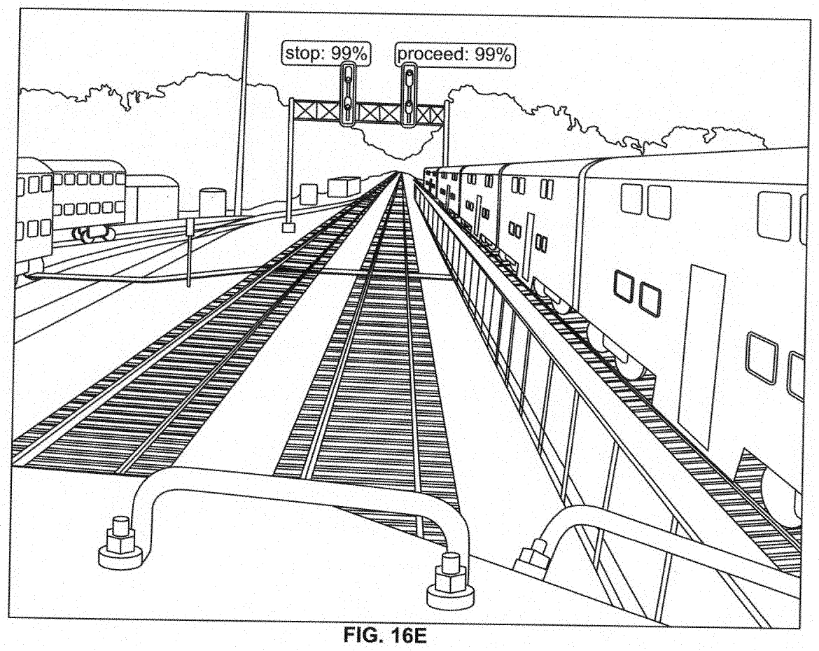

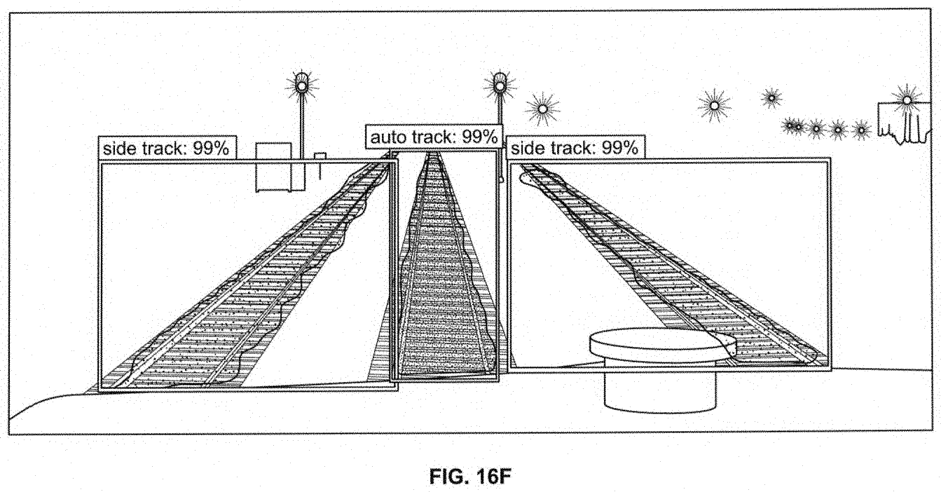

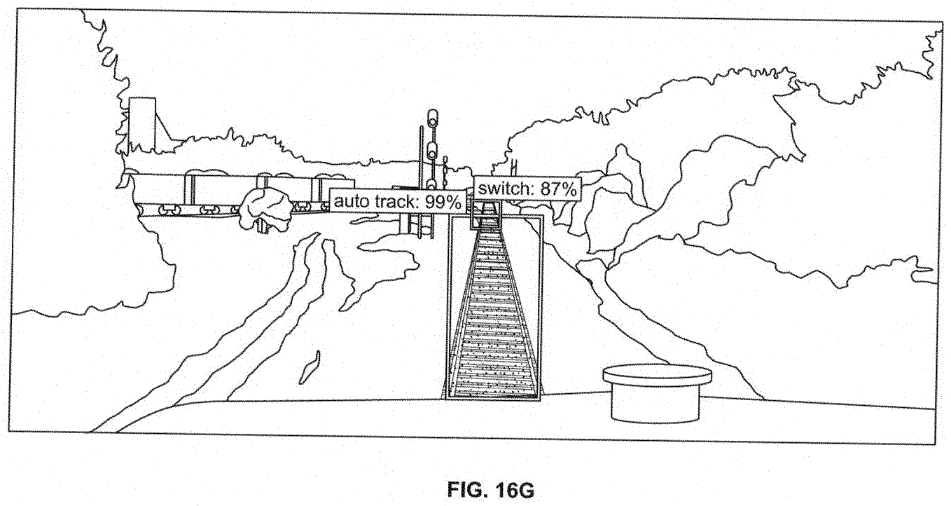

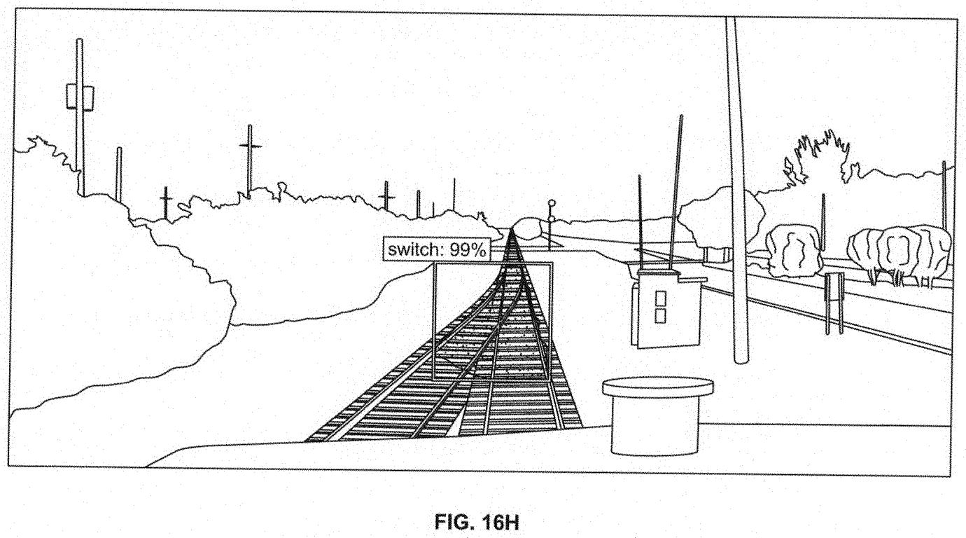

The remotely located user 968 can access video data, audio data, internal and/or external status determination, object detection and location information, obstruction detection information, and any other information stored in the remote data repository 948, including track information, asset information, and cab occupancy information, relating to the specific asset 964, or a plurality of assets, using the standard web client 962, such as a web browser, or a virtual reality device (not shown), such as the virtual reality device 828 of FIG. 8, which, in this implementation, can display thumbnail images of selected cameras. The web client 962 communicates the user's 968 request for information to a web server 958 through a network 960 using common web standards, protocols, and techniques. Network 960 can be, for example, the Internet. Network 960 can also be a local area network (LAN), metropolitan area network (MAN), wide area network (WAN), virtual private network (VPN), a cellular telephone network or any other means of transferring data from the web server 958 to, in this example, the web client 962. The web server 958 requests the desired data from the remote data repository 948 and the data decoder 954 obtains the requested data relating to the specific asset 964 from the remote data repository 948 upon request from the web server 958. The data decoder 954 decodes the requested data and sends the decoded data to a localizer 956. The localizer 956 identifies the profile settings set by user 968 by accessing the web client 962 and using the profile settings to prepare the information being sent to the web client 962 for presentation to the user 968, as the raw encoded data and detected track/object detection/location information is saved to the remote data repository 948 using coordinated universal time (UTC) and international system of units (SI units). The localizer 956 converts the decoded data into a format desired by the user 968, such as the user's 968 preferred unit of measure and language. The localizer 956 sends the localized data in the user's 968 preferred format to the web server 958 as requested. The web server 958 then sends the localized data to the web client 962 for viewing and analysis, providing playback and real-time display of standard video and 360 degrees video, along with the internal and/or external status determination, object detection and location information, and obstruction detection information, such as the track and/or object detection (FIG. 16A), track and switch detection (FIG. 16B), track and/or object detection, count the number of tracks, and signal detection (FIG. 16C), crossing and track and/or object detection (FIG. 16D), dual overhead signal detection (FIG. 16E), multi-track and/or multi-object detection (FIG. 16F), switch and track and/or object detection (FIG. 16G), and switch detection (FIG. 16H).

The web client 962 is enhanced with a software application that provides the playback of 360 degrees video and/or other video in a variety of different modes. The user 968 can elect the mode in which the software application presents the video playback such as, for example, fisheye view, dewarped view, panorama view, double panorama view, and quad view.

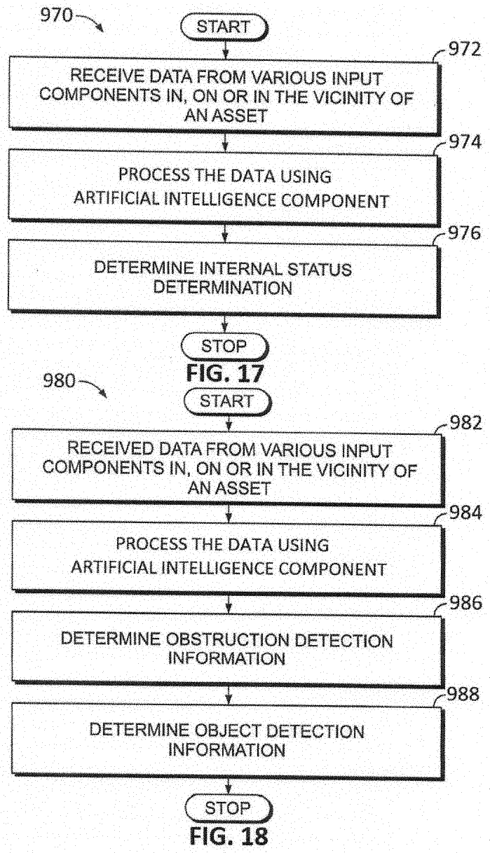

FIG. 17 is a flow diagram showing a process 970 for determining an internal status of the asset 964 in accordance with an implementation of this disclosure. The video analytics system 910 receives data signals from various input components 972, such as cameras 940, including but not limited to 360 degrees cameras, fixed cameras, narrow view cameras, wide view cameras, 360 degrees fisheye view cameras, radar, LIDAR, and/or other cameras, on, in or in vicinity of the asset 964, vehicle data component 934, weather component 936, and route/manifest/GIS component 938. The video analytics system 910 processes the data signals using supervised learning and/or reinforcement learning component 974 and determines an internal status 976 such as cab occupancy.

FIG. 18 is a flow diagram showing a process 980 for determining object detection/location and obstruction detection occurring externally and internally to the asset 964 in accordance with an implementation of this disclosure. The video analytics system 910 receives data signals from various input components 982, such as cameras 940, including, but not limited to, 360 degrees cameras, fixed cameras, narrow view cameras, wide view cameras, 360 degrees fisheye view cameras, radar, LIDAR, and/or other cameras, on, in or in vicinity of the asset 964, vehicle data component 934, weather component 936, and route/manifest/GIS component 938. The video analytics system 910 processes the data signals using the supervised learning and/or reinforcement learning component 924, the object detection/location component 926, and the obstruction detection component 928 984 and determines obstruction detection 986 and object detection and location 988 such as track presence.

For simplicity of explanation, process 970 and process 980 are depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

A seventh embodiment of a real-time data acquisition and recording system and automated signal compliance monitoring and alerting system described herein provides real-time, or near real-time, access to a wide range of data, such as event and operational data, video data, and audio data, related to a high value asset to remotely located users such as asset owners, operators and investigators. The automated signal compliance monitoring and alerting system records data, via a data recorder, relating to the asset and streams the data to a remote data repository and remotely located users prior to, during, and after an incident has occurred. The data is streamed to the remote data repository in real-time, or near real-time, making information available at least up to the time of an incident or emergency situation, thereby virtually eliminating the need to locate and download the “black box” in order to investigate an incident involving the asset and eliminating the need to interact with the data recorder on the asset to request a download of specific data, to locate and transfer files, and to use a custom application to view the data. The system of the present disclosure retains typical recording capability and adds the ability to stream data to a remote data repository and remote end user prior to, during, and after an incident. In the vast majority of situations, the information recorded in the data recorder is redundant and not required as data has already been acquired and stored in the remote data repository.

The automated signal monitoring and alerting system also automatically monitors and provides historical and real-time alerting for mobile assets, such as locomotives, trains, airplanes, and automobiles, in violation of a signal aspect, such as a stop light, traffic light, and/or speed limit signal, or operating the mobile asset unsafely in an attempt to maintain compliance to a signal, such as a stop light, traffic light, and/or speed limit signal. The automated signal monitoring and alerting system combines the use of image analytics, GPS location, braking forces, and vehicles speed, as well as automated electronic notifications, to alert personnel onboard and/or off-board the mobile asset in real-time when a mobile asset violates safe operating rules, such as, for example, when a stop signal is passed by a mobile asset prior to stopping and receiving authority (red light violation), when a restricting signal indicating reduced speed limits is violated by a mobile asset traveling at greater speed, and when a mobile asset applies late and/or excessive braking forces in order to stop before passing a stop/red signal.

Prior to the automated signal monitoring and alerting system of the present disclosure, operations center personnel relied on mobile asset crews to report when a safe operating rule is violated. Sometimes a catastrophic mobile asset on mobile asset collision resulted, with subsequent investigations realizing the safe operating rules violation had occurred. Additionally, excessive braking forces may have caused mechanical failure to a part of the mobile asset and in situations where the mobile asset is a locomotive and/or train, excessive braking forces may have resulted in derailment, with subsequent investigations finding the safe operating rule violation as the root cause. The system of the present disclosure enables users to monitor and/or be alerted when a safe operating rule violation occurs, prior to mechanical failure, collision, derailment, and/or another accident occurs.

An end user may subscribe to be alerted when a safe operating rule violation has occurred, and will receive email, text message, and/or in-browser electronic notifications within minutes of the actual event occurring. The end user may utilize historical records to analyze data to identify patterns, such as, for example, problem locations, compromised line of sight, faulty equipment, and underperforming crews, which can be useful in implementing new and safer operating rules or crew educational opportunities for continuous improvement. The system of the present disclosure enables the end user to leverage continuous electronic monitoring and extensive image analytics to understand any and all times when a mobile asset is operating unsafely due to a safe operating rule violation and/or signal non-compliance.

The automated signal monitoring and alerting system is used by vehicle and/or mobile asset owners, operators, and investigators to view and analyze the operational efficiency and safety of mobile assets in real-time. The ability to view operations in real-time enables rapid evaluation and adjustment of behavior. During an incident, real-time information can facilitate triaging the situation and provide valuable information to first responders. During normal operation, near real-time information can be used to audit crew performance and to aid network wide operational safety and awareness.

The automated signal monitoring and alerting system utilizes outward facing cameras and/or other cameras, GPS location, speed, and acceleration, as well as vehicle, train, and/or mobile asset brake pressure sensor data in a completely integrated, time-synchronized, automated system to identify unsafe and potentially catastrophic operating practices to provide real-time feedback to mobile asset crews and management. The automated signal monitoring and alerting system also provides automated data and video download to users with various data sources so as to allow complete knowledge of the operating environment at the time of alerting.

Data may include, but is not limited to, analog and digital parameters such as speed, pressure, temperature, current, voltage, and acceleration which originate from the asset and/or nearby assets; Boolean data such as switch positions, actuator position, warning light illumination, and actuator commands; global positioning system (GPS) data and/or geographic information system (GIS) data such as position, speed, and altitude; internally generated information such as the regulatory speed limit for an asset given its current position; video and image information from cameras located at various locations in, on or in the vicinity of the asset; audio information from microphones located at various locations in, on or in vicinity of the asset; information about the operational plan for the asset that is sent to the asset from a data center such as route, schedule, and cargo manifest information; information about the environmental conditions, including current and forecasted weather conditions, of the area in which the asset is currently operating in or is planned to operate in; asset control status and operational data generated by systems such as positive train control (PTC) in locomotives; and data derived from a combination from any of the above including, but not limited to, additional data, video, and audio analysis and analytics.

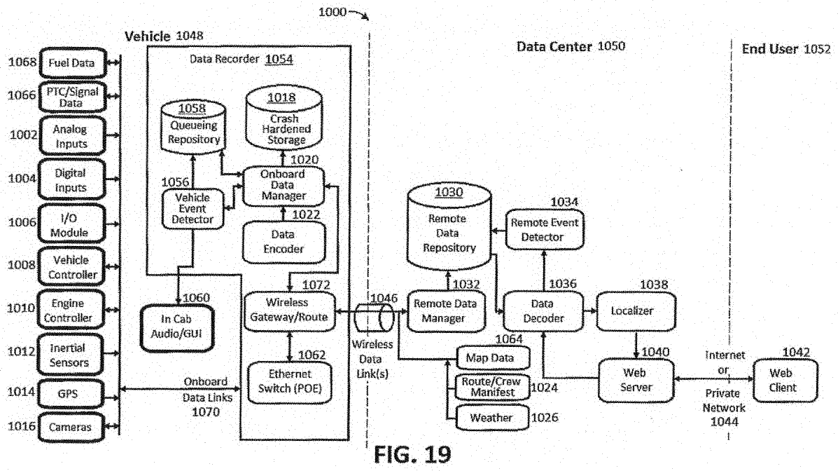

FIG. 19 illustrates a field implementation of the seventh embodiment of the exemplary real-time data acquisition and recording system (DARS) 1000 and automated signal monitoring and alerting system 1080 in which aspects of the disclosure can be implemented. DARS 1000 is a system that delivers real time information to remotely located end users from a data recording device. DARS 1000 includes a data recorder 1054 that is installed on a vehicle or mobile asset 1048 and communicates with any number of various information sources through any combination of onboard wired and/or wireless data links 1070 such as a wireless gateway/router, or off-board information sources via a data center 1050 of DARS 1000 via data links such as wireless data links 1046. Data recorder 1054 comprises an onboard data manager 1020, a data encoder 1022, a vehicle event detector 1056, a queueing repository 1058, and a wireless gateway/router 1072. Additionally, in this implementation, data recorder 1054 can include a crash hardened memory module 1018 and/or an Ethernet switch 1062 with or without power over Ethernet (POE). An exemplary hardened memory module 1018 can be, for example, a crashworthy event recorder memory module that complies with the Code of Federal Regulations and/or the Federal Railroad Administration regulations, a crash survivable memory unit that complies with the Code of Federal Regulations and/or the Federal Aviation Administration regulations, a crash hardened memory module in compliance with any applicable Code of Federal Regulations, or any other suitable hardened memory device as is known in the art. In an eighth embodiment, the data recorder can further include an optional non-crash hardened removable storage device (not shown).

The wired and/or wireless data links 1070 can include any one of or combination of discrete signal inputs, standard or proprietary Ethernet, serial connections, and wireless connections. Ethernet connected devices may utilize the data recorder's 1054 Ethernet switch 1062 and can utilize POE. Ethernet switch 1062 may be internal or external and may support POE. Additionally, data from remote data sources, such as a map component 1064, a route/crew manifest component 1024, and a weather component 1026 in the implementation of FIG. 19, is available to the onboard data manager 1020 and the vehicle event detector 1056 from the data center 1050 through the wireless data link 1046 and the wireless gateway/router 1072.

Data recorder 1054 gathers data or information from a wide variety of sources, which can vary widely based on the asset's configuration, through onboard data link 1070. The data encoder 1022 encodes at least a minimum set of data that is typically defined by a regulatory agency. In this implementation, the data encoder 1022 receives data from a wide variety of asset 1048 sources and data center 1050 sources. Information sources can include any number of components in the asset 1048, such as any of analog inputs 1002, digital inputs 1004, I/O module 1006, vehicle controller 1008, engine controller 1010, inertial sensors 1012, global positioning system (GPS) 1014, cameras 1016, positive train control (PTC)/signal data 1066, fuel data 1068, cellular transmission detectors (not shown), internally driven data and any additional data signals, and any of number of components in the data center 1050, such as any of the route/crew manifest component 1024, the weather component 1026, the map component 1064, and any additional data signals. Furthermore, asset 1048 information sources can be connected to the data recorder 1054 through any combination of wired or wireless data links 1070. The data encoder 1022 compresses or encodes the data and time synchronizes the data in order to facilitate efficient real-time transmission and replication to a remote data repository 1030. The data encoder 1022 transmits the encoded data to the onboard data manager 1020 which then saves the encoded data in the crash hardened memory module 1018 and the queuing repository 1058 for replication to the remote data repository 1030 via a remote data manager 1032 located in the data center 1050. Optionally, the onboard data manager 1020 can save a tertiary copy of the encoded data in the non-crash hardened removable storage device of the eighth embodiment. The onboard data manager 1020 and the remote data manager 1032 work in unison to manage the data replication process. A single remote data manager 1032 in the data center 1050 can manage the replication of data from a plurality of assets 1048.

The data from the various input components and data from an in-cab audio/graphical user interface (GUI) 1060 are sent to a vehicle event detector 1056. The vehicle event detector 1056 processes the data to determine whether an event, incident or other predefined situation involving the asset 1048 has occurred. When the vehicle event detector 1056 detects signals that indicate a predefined event occurred, the vehicle event detector 1056 sends the processed data that a predefined event occurred along with supporting data surrounding the predefined event to the onboard data manager 1020. The vehicle event detector 1056 detects events based on data from a wide variety of sources, such as the analog inputs 1002, the digital inputs 1004, the I/O module 1006, the vehicle controller 1008, the engine controller 1010, the inertial sensors 1012, the GPS 1014, the cameras 1016, the route/crew manifest component 1024, the weather component 1026, the map component 1064, the PTC/signal data 1066, and the fuel data 1068, which can vary based on the asset's configuration. When the vehicle event detector 1056 detects an event, the detected asset event information is stored in a queuing repository 1058 and can optionally be presented to the crew of the asset 1048 via the in-cab audio/graphical user interface (GUI) 1060.

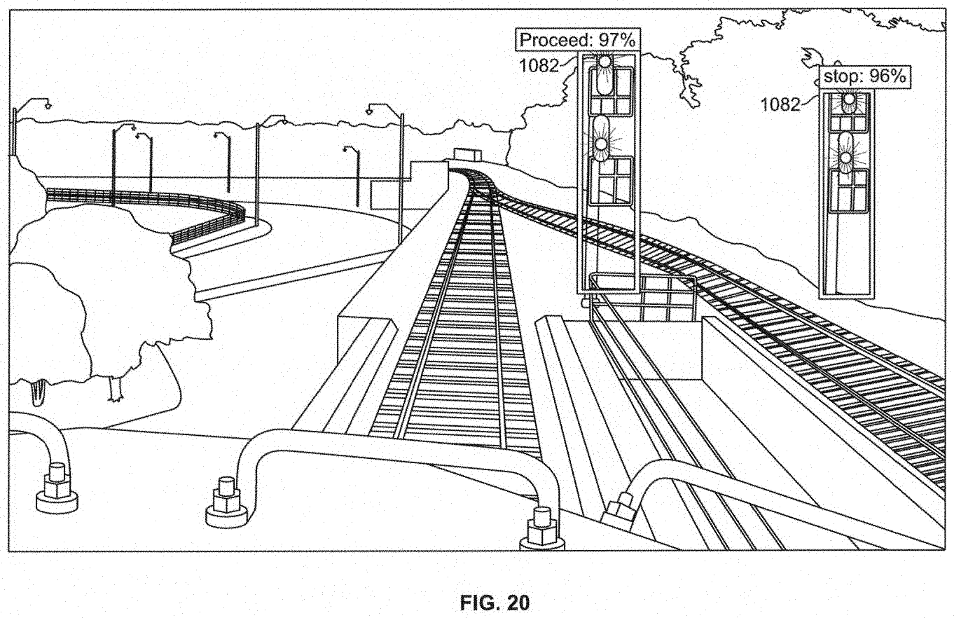

When the asset's 1048 location indicates that a signal 1082 has been crossed, excessive braking has occurred and the asset 1048 stopped within close location of the signal 1082, or speed restrictions applied be means of signal aspect, the onboard data manager 1020 will initiate outward facing camera image analysis to determine the meaning or aspect of the signal 1082, as shown in FIG. 20. Utilizing state of the art image processing techniques, outward facing camera footage can be analyzed by a previously trained neural network or artificial intelligence component to decipher signal aspect and operating rules implications. The analysis and/or processing by the neural network or artificial intelligence component, in this exemplary implementation, is done in a back office. In another embodiment, the analysis and/or processing by the neural network or artificial intelligence component is done on the asset 1048. The output of the signal aspect decoding is combined with other sensor data to determine whether the asset 1048 has grossly violated signal indication by occupying railroad tracks, in this exemplary implementation, which may lead to a train on train collision, or has operated in an unsafe manner to achieve signal compliance. When the asset 1048 is found to be out of compliance, an electronic alert will be stored in the back office, as well as delivered to users who have subscribed to receive such alerts, after associating the railroad's business rules to the signal and asset operations. These alerts can then be mined either directly via a database or by using the website graphical user interface, or a web client 1042, provided to users.

Additionally, an audible alert can be added to the cab of the asset 1048 which would alert the crew of an impending signal violation, impending bad situation that the crew may respond to faster in case the crew was distracted or otherwise not paying attention to a track obstruction, stop signal, and/or if the asset 1048 is speeding in a zone where the signal requires a lower speed limit.

The automated signal monitoring and alerting system 1080 is also enhanced to automatically perform video analytics to determine signal meaning each time a monitored asset crosses a signal, to automatically perform video analytics to determine signal meaning whenever an asset experiences excessive braking forces and comes to a stop within a pre-defined distance, and to monitor asset speed to determine whether the asset is moving at a speed greater than is authorized as determined by the signal aspect. The image analytics is done onboard the asset 1048 to reduce delay between the actual event and the electronic notification to users and/or subscribers. The functionality of the automated signal monitoring and alerting system 1080 is enhanced to allow automated inward and outward facing video downloads at the time of alert to enhance the user's experience and decrease the work necessary to investigate the event. The functionality of the automated signal monitoring and alerting system 1080 is also enhanced to provide real-time audible cues within the non-compliant asset 1048 to alert crew in case of distraction or other reason for not following safe operating practices with respect to signal rules and meaning.

Additionally, the automated signal monitoring and alerting system 1080 and/or video analytics system 910 may receive location information, including latitude and longitude coordinates, of a signal, such as a stop signal, traffic signal, speed limit signal, and/or object signal near the tracks, from the asset owner. The video analytics system 910 then determines whether the location information received from the asset owner is correct. If the location information is correct, the video analytics system 910 stores the information and will not recheck the location information again for a predetermined amount of time, such as checking the location information on a monthly basis. If the location information is not correct, the video analytics system 910 determines the correct location information and reports the correct location information to the asset owners, stores the location information, and will not recheck the location information again for a predetermined amount of time, such as checking the location information on a monthly basis. Storing the location information provides easier detection of a signal, such as a stop signal, traffic signal, speed limit signal, and/or object signal near the tracks.

The onboard data manager 1020 also sends data to the queuing repository 1058. In near real-time mode, the onboard data manager 1020 stores the encoded data received from the data encoder 1022 and any event information in the crash hardened memory module 1018 and in the queueing repository 1058. In the eighth embodiment, the onboard data manager 1020 can optionally store the encoded data in the non-crash hardened removable storage device. After five minutes of encoded data has accumulated in the queuing repository 1058, the onboard data manager 1020 stores the five minutes of encoded data to the remote data repository 1030 via the remote data manager 1032 in the data center 1050 over the wireless data link 1046 accessed through the wireless gateway/router 1072. In real-time mode, the onboard data manager 1020 stores the encoded data received from the data encoder 1022 and any event information to the crash hardened memory module 1018, and optionally in the non-crash hardened removable storage device of the eighth embodiment, and to the remote data repository 1030 via the remote data manager 1032 in the data center 1050 over the wireless data link 1046 accessed through the wireless gateway/router 1072. The process of replicating data to the remote data repository 1030 requires a wireless data connection between the asset 1048 and the data center 1050. The onboard data manager 1020 and the remote data manager 1032 can communicate over a variety of wireless communications links, such as Wi-Fi, cellular, satellite, and private wireless systems utilizing the wireless gateway/router 1072. Wireless data link 1046 can be, for example, a wireless local area network (WLAN), wireless metropolitan area network (WMAN), wireless wide area network (WWAN), a private wireless system, a cellular telephone network or any other means of transferring data from the data recorder 1054 of DARS 1000 to, in this example, the remote data manager 1030 of DARS 1000. When a wireless data connection is not available, the data is stored in memory and queued in queueing repository 1058 until wireless connectivity is restored and the data replication process can resume.

In parallel with data recording, data recorder 1054 continuously and autonomously replicates data to the remote data repository 1030. The replication process has two modes, a real-time mode and a near real-time mode. In real-time mode, the data is replicated to the remote data repository 1030 every second. In near real-time mode, the data is replicated to the remote data repository 1030 every five minutes. The rates used for near real-time mode and real-time mode are configurable and the rate used for real-time mode can be adjusted to support high resolution data by replicating data to the remote data repository 1030 every 0.10 seconds. When the DARS 1000 is in near real-time mode, the onboard data manager 1020 queues data in the queuing repository 1058 before replicating the data to the remote data manager 1032. The onboard data manager 1020 also replicates the vehicle event detector information queued in the queueing repository 1058 to the remote data manager 1032. Near real-time mode is used during normal operation, under most conditions, in order to improve the efficiency of the data replication process.

Real-time mode can be initiated based on events occurring and detected by the vehicle event detector 1056 onboard the asset 1048 or by a request initiated from the data center 1050. A typical data center 1050 initiated request for real-time mode is initiated when a remotely located user 1052 has requested real-time information from the web client 1042. A typical reason for real-time mode to originate onboard the asset 1048 is the detection of an event or incident by the vehicle event detector 1056 such as an operator initiating an emergency stop request, emergency braking activity, rapid acceleration or deceleration in any axis, or loss of input power to the data recorder 1054. When transitioning from near real-time mode to real-time mode, all data not yet replicated to the remote data repository 1030 is replicated and stored in the remote data repository 1030 and then live replication is initiated. The transition between near real-time mode and real-time mode typically occurs in less than five seconds. After a predetermined amount of time has passed since the event or incident, a predetermined amount of time of inactivity, or when the user 1052 no longer desires real-time information from the asset 1048, the data recorder 1054 reverts to near real-time mode. The predetermined amount of time required to initiate the transition is configurable and is typically set to ten minutes.

When the data recorder 1054 is in real-time mode, the onboard data manager 1020 attempts to continuously empty its queue to the remote data manager 1032, storing the data to the crash hardened memory module 1018, and optionally to the non-crash hardened removable storage device of the eighth embodiment, and sending the data to the remote data manager 1032 simultaneously. The onboard data manager 1020 also sends the detected vehicle information queued in the queuing repository 1058 to the remote data manager 1032.

Upon receiving data to be replicated from the data recorder 1054, along with data from the map component 1064, the route/crew manifest component 1024, and the weather component 1026, the remote data manager 1032 stores the compressed data to the remote data repository 1030 in the data center 1050 of DARS 1000. The remote data repository 1030 can be, for example, cloud-based data storage or any other suitable remote data storage. When data is received, a process is initiated that causes a data decoder 1036 to decode the recently replicated data for/from the remote data repository 1030 and send the decoded data to a remote event detector 1034. The remote data manager 1032 stores vehicle event information in the remote data repository 1030. When the remote event detector 1034 receives the decoded data, it processes the decoded data to determine if an event of interest is found in the decoded data. The decoded information is then used by the remote event detector 1034 to detect events, incidents, or other predefined situations, in the data occurring with the asset 1048. Upon detecting an event of interest from the decoded data, the remote event detector 1034 stores the event information and supporting data in the remote data repository 1030. When the remote data manager 1032 receives remote event detector 1034 information, the remote data manager 1032 stores the information in the remote data repository 1030.

The remotely located user 1052 can access information, including vehicle event detector information, relating to the specific asset 1048, or a plurality of assets, using the standard web client 1042, such as a web browser, or a virtual reality device (not shown) which, in this implementation, can display thumbnail images from selected cameras. The web client 1042 communicates the user's 1052 request for information to a web server 1040 through a network 1044 using common web standards, protocols, and techniques. Network 1044 can be, for example, the Internet. Network 1044 can also be a local area network (LAN), metropolitan area network (MAN), wide area network (WAN), virtual private network (VPN), a cellular telephone network or any other means of transferring data from the web server 1040 to, in this example, the web client 1042. The web server 1040 requests the desired data from the data decoder 1036. The data decoder 1036 obtains the requested data relating to the specific asset 1048, or plurality of assets, from the remote data repository 1030 upon request from the web server 1040. The data decoder 1036 decodes the requested data and sends the decoded data to a localizer 1038. Localization is the process of converting data to formats desired by the end user, such as converting the data to the user's preferred language and units of measure. The localizer 1038 identifies the profile settings set by user 1052 by accessing the web client 1042 and uses the profile settings to prepare the information being sent to the web client 1042 for presentation to the user 1052, as the raw encoded data and detected event information is saved to the remote data repository 1030 using coordinated universal time (UTC) and international system of units (SI units). The localizer 1038 converts the decoded data into a format desired by the user 1052, such as the user's 1052 preferred language and units of measure. The localizer 1038 sends the localized data in the user's 1052 preferred format to the web server 1040 as requested. The web server 1040 then sends the localized data of the asset, or plurality of assets, to the web client 1042 for viewing and analysis, providing playback and real-time display of standard video, 360 degrees video, and/or other video. The web client 1042 can display and the user 1052 can view the data, video, and audio for a single asset or simultaneously view the data, video, and audio for a plurality of assets. The web client 1042 can also provide synchronous playback and real-time display of data along with the plurality of video and audio data from image measuring sources, standard video sources, 360 degrees video sources, and/or other video sources, and/or range measuring sources, on, in, or in the vicinity of the asset, nearby assets, and/or remotely located sites.

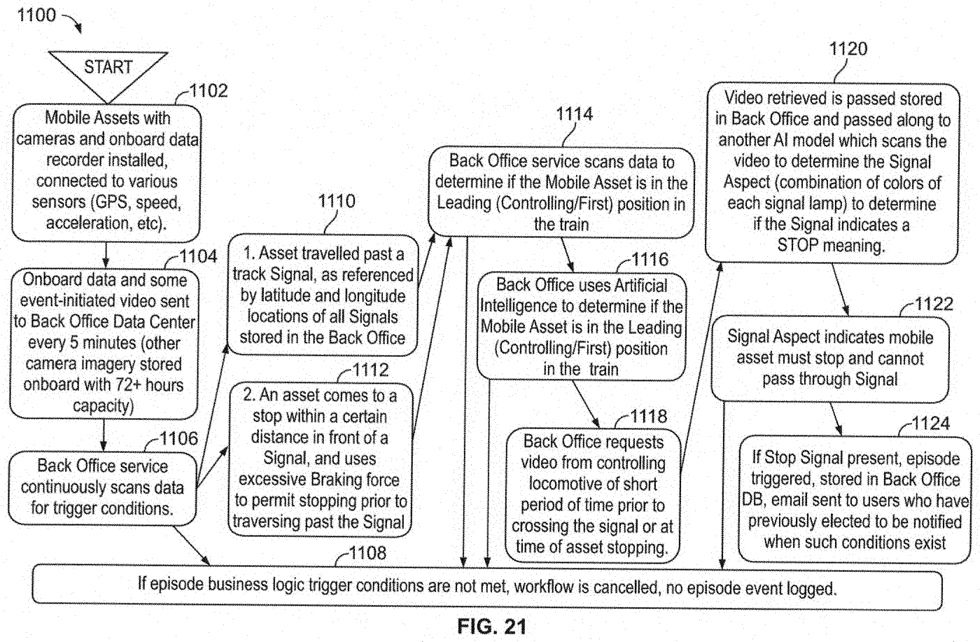

FIG. 21 is a flow diagram showing a first illustrated embodiment of a process 1100 for determining signal compliance in accordance with an implementation of this disclosure. After the DARS 1000 and cameras 1016 are installed and connected to various sensors on the asset 1048, such as analog inputs 1002, digital inputs 1004, I/O module 1006, vehicle controller 1008, engine controller 1010, inertial sensors 1012, global positioning system (GPS) 1014, cameras 1016, positive train control (PTC)/signal data 1066, fuel data 1068, cellular transmission detectors (not shown), internally driven data and any additional data signals, 1102, onboard data from the various sensors and/or event-initiated video and/or still images are sent to a back office data center 1074 every five minutes and camera imagery is stored onboard the asset 1048 with over 72 hours of capacity 1104. The back office data center 1074 service continuously scans the data for trigger conditions 1106. If episode business logic trigger conditions are not met, the workflow is cancelled and no episode event is logged 1108. If the asset 1048 travelled past a track signal 1082 as referenced by latitude and longitude coordinates of all signals stored in the back office data center 1074 1110 and/or the asset 1048 came to a stop within a certain distance in front of the signal 1082 and used excessive braking force to permit stopping prior to traversing past the signal 1082 1112, the back office data center 1074 service scans the data to determine if the train car, in this illustrated embodiment, is in the leading, controlling, or first position in the train asset 1048 1114. The back office data center 1074 uses a first artificial intelligence model to determine if the train car is in the leading, controlling, or first position in the train asset 1048 1116. If the train car is not in the leading, controlling, or first position in the train asset 1048, the episode business logic trigger conditions are not met, the workflow is cancelled and no episode event is logged 1108. If the train car is in the leading, controlling, or first position in the train asset 1048, the back office data center 1074 requests video content from the lead, controlling, or first position locomotive taken a short period of time prior to crossing the signal 1082 and/or at the time of the asset 1048 stopping 1118. The video content retrieved is passed and/or stored in the back office data center 1074 and passed along to a second artificial intelligence model that scans the video content to determine the signal 1082 aspect, such as the combination of colors of each signal lamp, to determine if the signal 1082 indicates a STOP meaning 1120. The back office data center 1074 determines whether the signal 1082 aspect indicates that the asset 1048 must stop and cannot pass through the signal 1082 1122. If the signal 1082 aspect does not indicate that the asset 1048 must stop and cannot pass through the signal 1082, the episode business logic trigger conditions are not met, the workflow is cancelled and no episode event is logged 1108. If the signal 1082 aspect does indicate that the asset 1048 must stop and cannot pass through the signal 1082 and the stop signal is present, an episode is triggered, stored in the back office data center 1074 database, and emails are sent to users who have previously elected to be notified when such conditions exist 1124.

For simplicity of explanation, process 1100 is depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

Train engineers who operate certain classes of mobile assets are required by federal regulations in many countries to undergo a test to confirm their skills and abilities, and become re-certified by passing this test as part of regulatory compliance for the geographical location in which the engineer operates. One example of this skills performance assessment in the United States is 49 C.F.R. § 240.127, which prescribes a test by the Federal Railroad Administration (FRA) for railroads operating over U.S. tracks. The stated purpose of the regulation is “to ensure only qualified persons operate a locomotive or train.” This regulation also prescribes minimum federal safety standards for eligibility, training, testing, certification and monitoring of all locomotive engineers to whom it applies. A railroad may issue certification for Train Service Engineers, Locomotive Servicing Engineers and Student Engineers.

As described in 49 C.F.R. § 240, railroads required to meet these standards must perform carefully prescribed evaluations and various train handling performance monitoring of their engineers on an annual, triannual, and periodic (audit) basis. There are presently three methods typically used by railroads to conduct an engineer performance evaluation. The first is to have an evaluator board the locomotive alongside the crew member under performance skills evaluation, and perform a ride-along during a specified train route. This method is labor intensive, requiring a Designated Supervisor of Locomotive Engineers to be physically present in the locomotive cab throughout the train movement segment being monitored. Also, the engineer undergoing evaluation is advised that he or she is being actively evaluated, and can tailor the operation of the mobile asset to avoid errors.

A second evaluation method uses a train simulator, which serves to reproduce visual, audible and sometimes even physical characteristics of train operator behavior in response to physical inputs and train characteristics. This method, however, does not provide an evaluation over a given distance of actual track.

A third method used to perform a skills performance evaluation is to acquire some or all of the locomotive event recorder data, including but not limited to, video image data from inward and outward facing cameras, external and internal audio, accelerometer and gyrometer data, fuel and weather data, train consist data, wayside information and movement authority for the ride being monitored captured over a specific train route. An analysis is performed either in real time, after a trip has taken place, or a combination of the two. This third method has proven to require less time and labor, improve the accuracy of the evaluation, and can be performed remotely.

Locomotive and train based simulators have created the ability to perform recertification in an environment which limits physical risk and increases safety while engineers are evaluated for performance. There is, however, no known automated system or platform which has been developed to reduce the amount of time taken to retrieve and assimilate relevant segments of data in an efficient and simple manner. The engineer recertification assistant of the present disclosure requires little more than having prior knowledge of important geographical locations to retrieve data for, important train handling signal combinations which can be monitored to automatically indicate poor train performance, a start/end time, and locomotive of interest. A user of the engineer recertification assistant simply presses a button, and hours and hours of manual work is now automatically done and presented in a highly consumable format in a secure web based portal and/or platform.

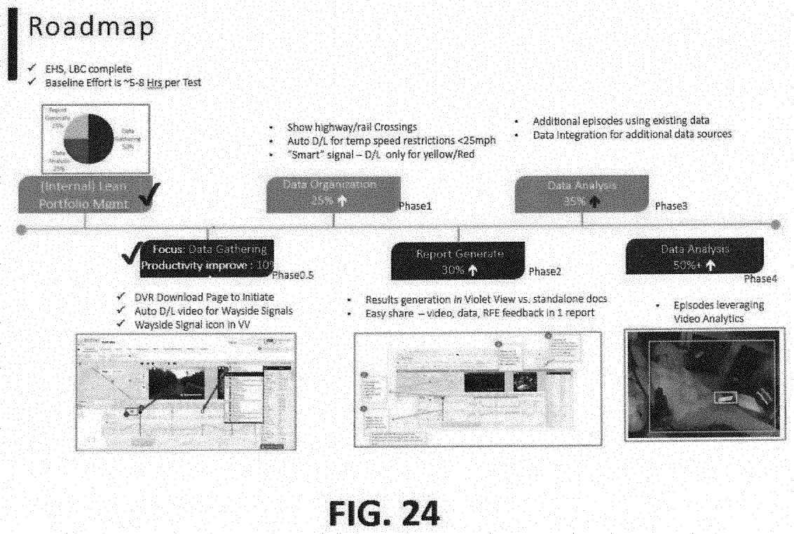

The improved engineer evaluation assistant described herein is an enhanced improvement to the third method described above, providing a more efficient and faster way to perform activities required for engineer evaluation in a unified user experience throughout the desired train route. The engineer recertification assistant of the present disclosure is an integrated online tool that significantly improves the engineer evaluation process by streamlining the activities required for evaluation into a unified user experience, increasing the productivity and accuracy of the engineer evaluation process. The engineer recertification assistant also provides a unified experience for engineer evaluation by providing bi-directional integration between the railroad's engineer evaluation portal and Applicant to enable. The engineer recertification assistant of the present disclosure improved data gathering by 10%, data organization by 25%, report generation by 30%, data analysis by 35%, and data analysis by over 50%, as shown in FIG. 24.

The presently described engineer evaluation method and system can be utilized to improve the efficiency of performance evaluation and engineer recertification in several ways.

First, after determining the right ride to evaluate crew (with the locomotive ID, train ID, date time stamps, sub division based or combination thereof), a railroad officer can simply press a button while logged into a secure portal, and utilize the present method and system to return video data from both inward and outward cameras automatically, for a range of scenarios related to locomotive, train, and wayside assets operations. Examples of scenarios are listed below. The ability to automate the video and event recorder capture process around train performance characteristics, geographical location of areas of interest, and specific operational areas of interest, is capable of saving large amounts of time and effort normally spent manually determining starting and ending times to request and retrieve video data. An additional advantage of the present disclosure is the ability to coordinate time-synchronized event recorder and geographic position data with video footage, allowing a comprehensive view of the locomotive cab and surroundings during critical evaluation periods of time.

Some examples of useful periods of time to analyze engineer performance include:
a. As the train passes by wayside signals, especially those signals indicating less than clear aspects (anything other than “all clear to proceed”);
b. Zones with temporary speed restrictions, which are not otherwise indicated by wayside signals indications and need to be evaluated for safety critical behavior. These zones may be put in operation to increase safety around job sites such as crews performing nearby track maintenance on adjacent tracks;
c. Grade crossings with pedestrian and vehicular traffic present;
d. Coupling and other excessive train forces typically found in stations and yards which may indicate unsafe behavior;
e. Braking scenarios both operationally as well as safety oriented; and
f. Train handling behaviors resulting in excessive or unsafe forces.

Second, while the railroad officer evaluates the engineer's performance, the officer will use the same secure web portal platform to perform various tasks related to reporting on the engineer's performance. Examples of functions that could be performed include:
a. Creating an online notebook to capture annotations and comments about the engineer's performance;
b. Sharing the entire ride along, including comments, with other officers; and
c. Summarizing the skills performance ride and results in report form to be used for regulatory submission or performance discussion with the engineer.

Third, in addition to data gathering and reporting, the method and system of the present disclosure will create additional checks to monitor engineer performance for any exceptions by comparing their performance to the test criteria as defined in regulatory compliance documents. An example of a railroad compliance document is FRA's 49 C.F.R. § 240.127. This substitutes the need for an officer to manually scan through the information (data, video, audio, etc.) for the entire ride to find these exceptions. Instead, algorithms are used to automatically identify these exceptions in the form of ‘events’ and present them via web portal by:
a. Leveraging a range of business algorithms and/or rules (from algorithms and linear heuristic models to advanced machine learning models) to monitor performance and for these checks to create real time events to identify exceptions.
b. Integrating with additional data sources as needed for gathering inputs for developing these algorithms. Examples include train control event logs and/or train dispatch management system logs.
c. The results of these are sent both as a real time alert to an email inbox or in the form of text or in browser alert. In addition, these exceptions are summarized in a report to provide consolidated results for customers to edit, review and share these with other railroad users.

Real time events are presented to railroad officers to evaluate engineer performance. An example of an event would be a train overspeed event that identifies when an engineer is operating a train exceeding authorized track speed, thereby violating criteria related to train handling. The railroad officer can review these events and determine if the engineer's performance was satisfactory or unsatisfactory. Other indicators and icons, such as geotagging of wayside assets such as signals and crossings

Additionally, results of real time events are converted into a satisfactory or unsatisfactory score for engineer performance using a combination of artificial intelligence (AI) and other algorithmic techniques. The system includes the capability to utilize algorithms to make certification or de-certification recommendations leading up to a fully automated system where the AI actually does de-certify for any detected gross non-compliance.

The disclosed method and system provides the following advantages, among others:
a. Push button retrieval of dozens or hundreds of inward and outward facing camera videos of pre-specified duration;
b. Easy and efficient grouping and visualization of key videos associated with an engineer recertification train segment;
c. Clear identification of key locations along a train route, key train handling characteristics associated with an engineer recertification train route;
d. Ability to capture key train handling events and operational performance by utilizing machine learning and event recorder signal analysis in a time synchronized method to identify important times to analyze and report on engineer performance. For example, machine learning is utilized to detect when a cellular phone is used inside the cab and then the event data recorder is utilized to filter out the results of the machine learning model and only show the locomotives the railroad is interested in, such as locomotives that were moving and/or locomotives that were in the lead position at the time of cellular phone use. The aim of the machine learning model is to provide image classification and object detection results. The aim of the event data recorder signals is to filter those results only for the cases that are relevant to the railroad's safety plan and/or operating rules; and
e. Capability to use a web portal platform to perform various tasks related to reporting on an engineer's performance.

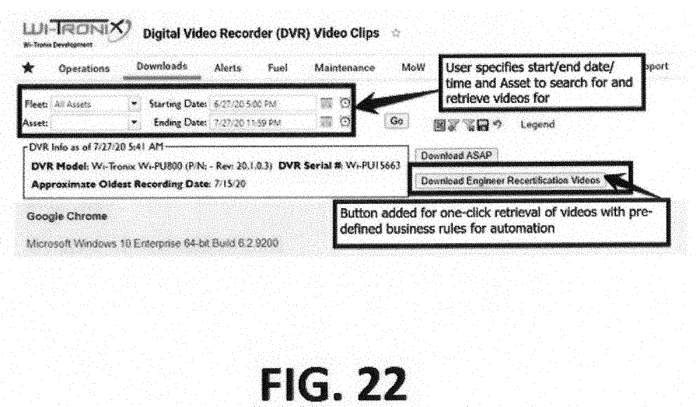

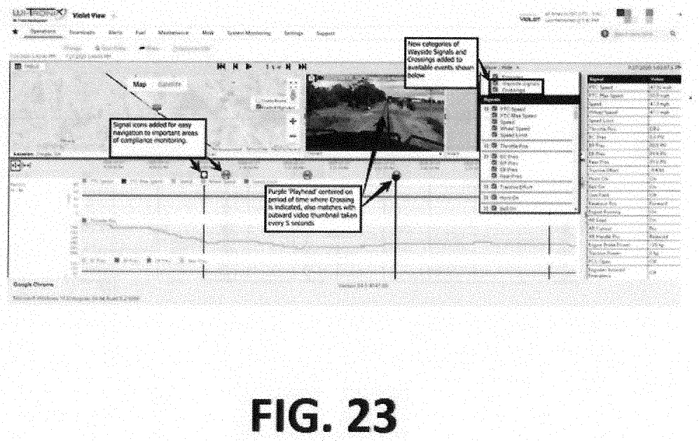

FIGS. 22 and 23 include some exemplary screenshots demonstrating some of the above concepts. FIG. 22 shows that an Engineer Recertification button is added to an existing page within the secure web portal. FIG. 23 shows an existing page enhanced with Engineer Recertification pre-defined events such as signal crossings. Videos taken will also be shown on this page for easy retrieval and viewing within the page. Indicators and icons, such as geotagging of wayside assets such as signals, crossings, speed zones, etc., are shown in the DARS viewer.

The engineer recertification assistant of the present disclosure comprises a system and method that aims at successfully conducting an engineer evaluation remotely by reducing managerial time spent collecting and assembling information to successfully administer annual, triannual, or skill performance audit in compliance with FRA 49 C.F.R. § 240.127. As shown in FIG. 24, the engineer recertification assistant controls costs by reducing 35% of engineer simulator run and associated training costs; improving engineer resource availability by moving simulator run to revenue services; increasing the road foreman of engineers' (RFE), or manager of locomotive crew, productivity by 50% through the automation of repeatable manual processes to successfully conduct several engineer evaluations remotely thereby allowing the RFE to better identify at-risk engineers, providing the RFE with more time to focus on at-risk engineers and modify behaviors, and providing post-monitoring and/or in person rides for at-risk engineers; and increasing the number of field certifications that meet 49 C.F.R. § 240.127 and driving a higher level of safety.

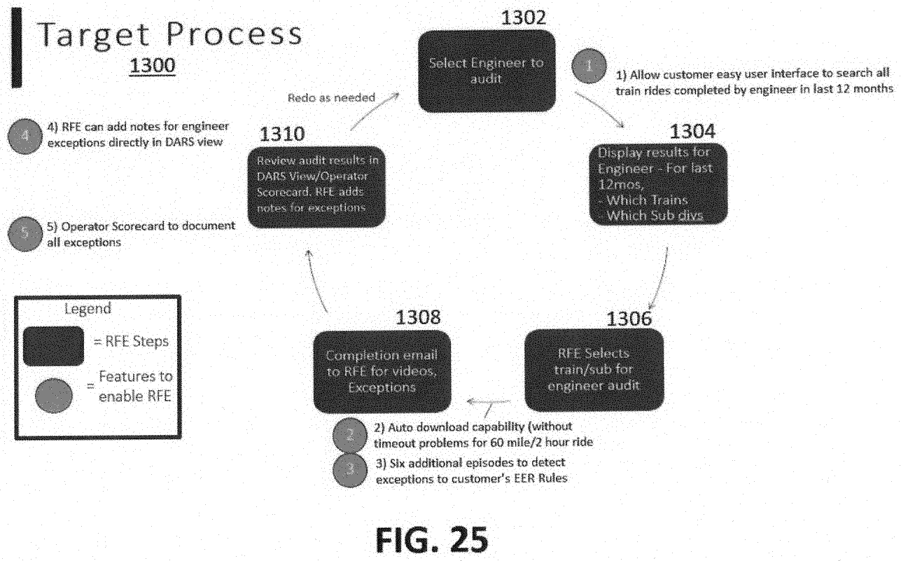

Referring to FIG. 25, a target process 1300 of first illustrated embodiment of a process performed by an engineer recertification assistant 1320 of the present disclosure comprises five steps performed by the RFE and Applicant's features to enable the RFE's corresponding steps. The engineer recertification assistant 1320 is an artificial intelligence (AI) implementation utilizing both video and operational data from with a real-time data acquisition and recording system, such as DARS 100, 200, 800, 900, 1000, analyzing the video and operational data with a video content analysis system, such as video analytics system 910, and reporting the video and operational data on a web-based viewer, such as web client 826. The engineer recertification assistant 1320 then combines that data with train and crew data to enable the railroad company to quickly assess information leading to a crew being certified or de-certified to operate a train in a given territory and route. The data collected and consolidated by the engineer recertification assistant 1320 for a human to then look at the AI selected events and points along the route to evaluate potential improper and/or unsafe train handling and violations of operating rules. Alternatively, the AI itself can review the selected events and points along the road to determine potential improper and/or unsafe train handling and violations of operating rules, determine an evaluation score, and recommend certification or decertification of the engineer or crew member or can certify or de-certify the engineer or crew member directly for any detected gross non-compliance.

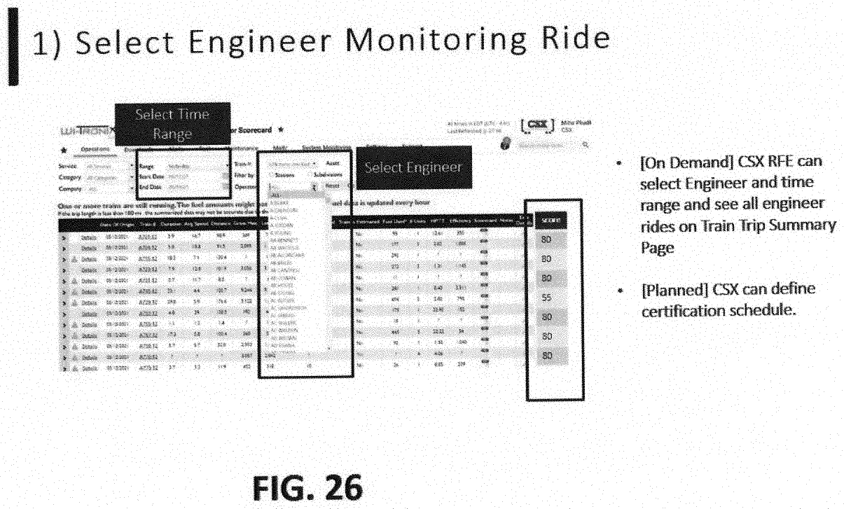

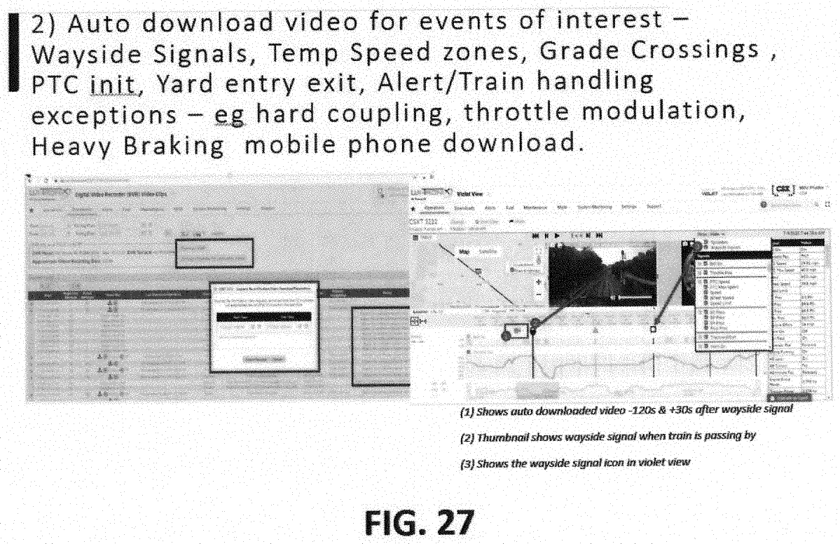

The engineer The RFE begins the evaluation process by selecting an engineer to audit 1302. In response, the system 1320 provides the customer with an easy user interface to search all train rides completed by that engineer in the last 12 months. As shown in FIG. 26, the RFE can perform an on demand audit by selecting the engineer and time range to see all engineer rides on a Train Trip Summary page or the customer can define a certification schedule. The user interface 826 then displays the results for that engineer for the last 12 months, including which trains and which sub divs the engineer operated 1304. As shown in FIG. 27, the system 1320 automatically downloads videos for events of interest, including but not limited to, wayside signals, temporary speed zones, grade crossings, PTC init, yard entry and/or exit, alert and/or train handling exceptions, e.g., hard coupling, throttle modulation, heavy braking, and cellular phone download. For example, the user interface 826 of FIG. 27 shows: 1) the automatically downloaded video comprising 120 seconds of video before the wayside signal and 30 seconds of video after the wayside signal; 2) thumbnail shows wayside signal when train is passing by; and 3) the wayside signal icon in DARS view.

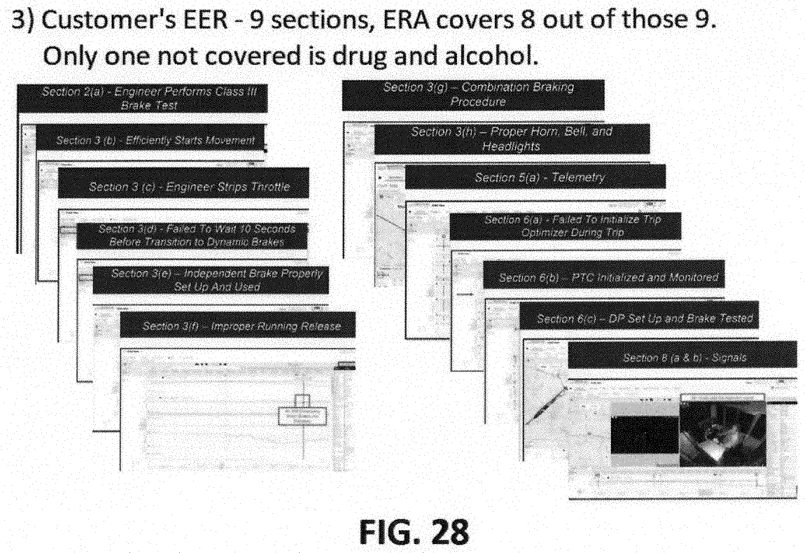

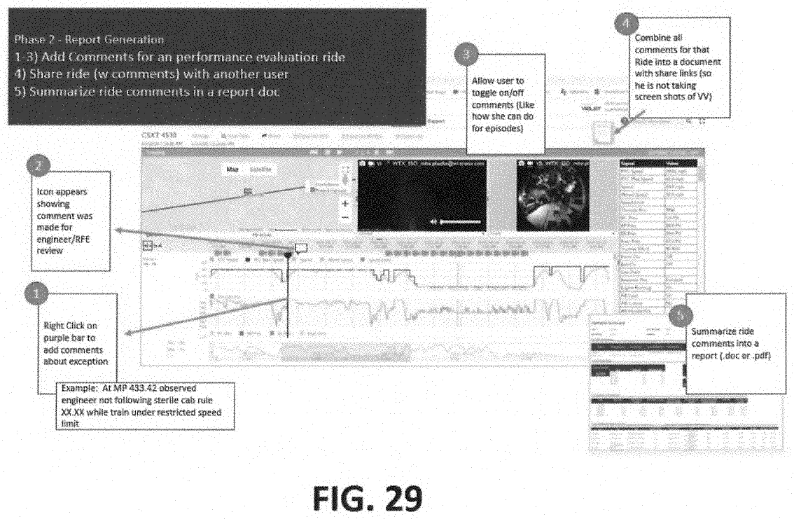

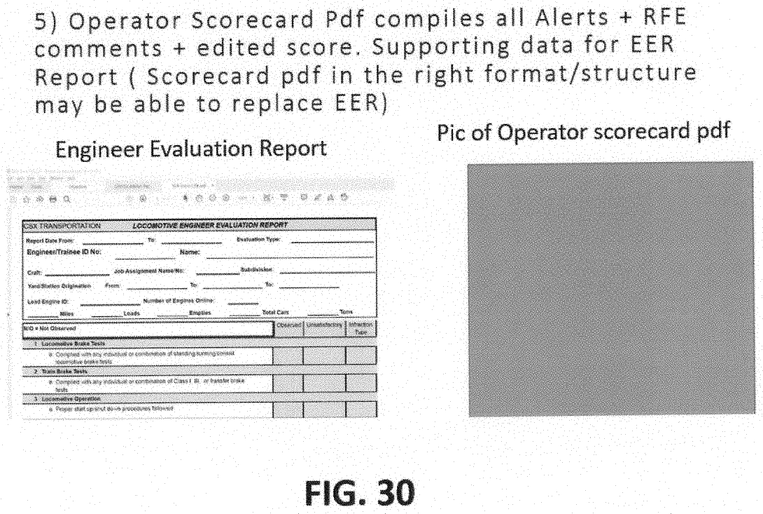

The RFE then selects a train/sub for the engineer audit 1306. The system 1320 provides automatic download capability for 60 miles/2 hour ride and six additional episodes to detect exceptions to the customer's engineer evaluation report (EER) rules. For example, as shown in FIG. 28, the customer's EER rules includes nine sections and the engineer recertification assistant 1320 of the present disclosure covers eight of those sections. The system 1320 then generates a completion email to the RFE for videos and/or exceptions 1308. The RFE and/or customer can review the audit results in the DARS viewer 826 and/or operator scorecard which also allows the RFE to add notes for engineer exceptions directly into the DARS viewer 826 and the operator scorecard documents all exceptions 1310. As shown in FIG. 29, the system 1320 will integrate within the Engineer Evaluation System or ERAD, which is the website where the customer performs engineer evaluations today, to comprise a one click approve or decline successful evaluation. The Engineer Evaluation System 1320 includes several features, including but not limited to, 1) the ability to right click on the purple bar to add comments for a performance evaluation ride and add comments about an exception, such as, for example, “at MP 433.42 observed engineer not following sterile cab rule XX.XX while train under restricted speed limit”; 2) an icon appears showing the comment was made for engineer and/or RFE review; 3) allows the user to toggle comments on or off, like the user can do for episodes as well; 4) combine all comments for that ride into a the operator scorecard document with share links so that the user is not required to take screenshots of the DARS viewer 826; and 5) summarize ride comments and/or exceptions into a report to provide a one stop shop for customers to edit, review, and share with other users. As shown in FIG. 30, the operator scorecard document compiles all alerts, RFE comments, an edited score, and supporting data for the EER. The operator scorecard document may be able to replace the EER if it's in the right format and/or structure. Process 1300 then repeats as needed.

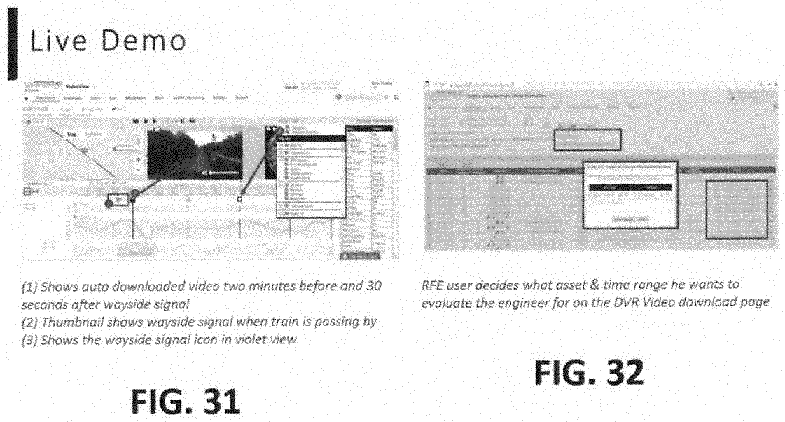

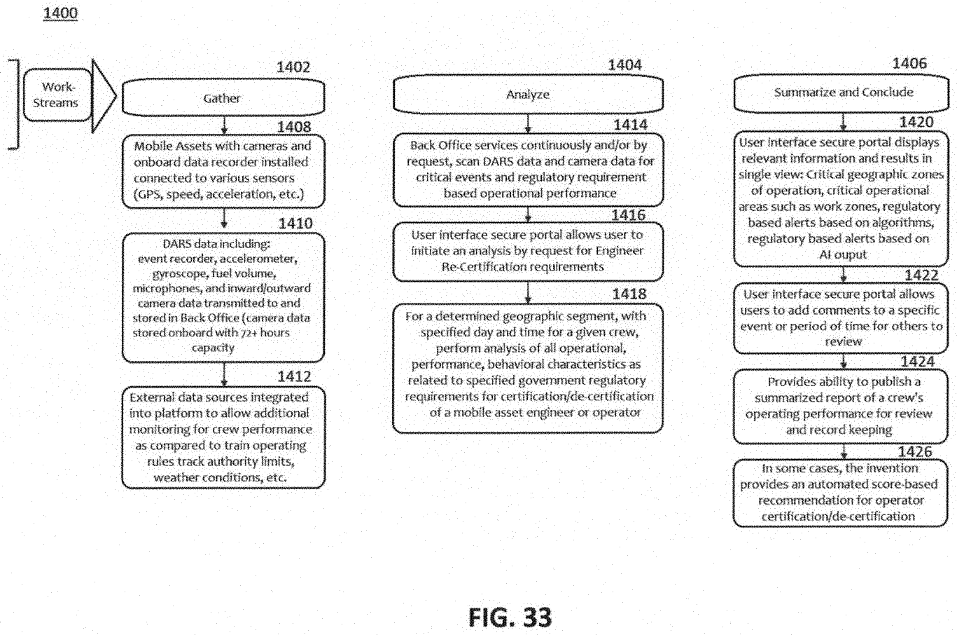

Screenshots of the DARS viewer 826 from a live demonstration of the engineer recertification assistant 1320 of the present disclosure are shown in FIGS. 31 and 32. The screenshot of FIG. 31 shows 1) auto downloaded video two minutes before and thirty seconds after a wayside signal; 2) a thumbnail that shows the wayside signal when the train is passing by; and 3) the wayside signal icon. The screenshot of FIG. 32 shows the RFE user deciding what asset and time range they want to evaluate the engineer for on the DVR video download page.

FIG. 22 is a flow diagram showing a second illustrated embodiment of a process 1400 performed by the engineer recertification assistant 1320 of the present disclosure. As described above with respect to process 1300, the engineer recertification assistant 1320 is an artificial intelligence (AI) implementation utilizing both video and operational data from with a real-time data acquisition and recording system, such as DARS 100, 200, 800, 900, 1000, analyzing the video and operational data with a video content analysis system, such as video analytics system 910, and reporting the video and operational data on a web-based viewer, such as web client 826. Process 1400 comprises three work streams in using computer based data and video to certify engineers, a data gathering and organizing work stream 1402, a data analysis work stream 1404, and a summarize and conclude report work stream 1406. The gather work stream 1402 identifies mobile assets with at least one camera, such as cameras 116, 216, 802, 940, 1016, and at least one onboard data recorder, such as data recorder 154, 254, 808, 902, 1054, installed and connected to various sensors, as described above, such as GPS, speed, acceleration, etc. 1408. The gather work stream 1402 can also obtain data from additional data sources such as PTC event logs and/or network dispatch system for gathering inputs for monitoring performance. The data collected from these mobile assets can comprise DARS data including event data recorder data, accelerometer data, gyroscope data, fuel volume data, microphones and inward and/or outward cameras data transmitted to and stored in the back office, and microphones and inward and/or outward cameras data stored onboard the mobile asset with at least 72 hours capacity 1410. The data collected from the external data sources is integrated into a platform to allow additional monitoring for crew performance as compared to train operating rules, track authority limits, weather conditions, etc. 1412.

The analyze work stream 1404 comprises back office services continuously and/or by request and scans DARS data and camera data for critical events and regulatory requirement based operational performance 1414. A user interface secure portal 826 allows users to initiate an analysis by request for engineer re-certification requirements 1416. For a determined geographic segment, with specified day and time for a given crew, the analyze work stream 1404 performs analysis of all operational, performance, and behavioral characteristics as related to specified government regulatory requirements for certification and/or de-certification of a mobile asset engineer and/or operator 1418.

The summarize and conclude work stream 1406 comprises a user interface secure portal 826 that displays relevant information and results in single view, which can include critical geographic zones of operation, critical operational areas such as work zones, regulatory-based alerts based on algorithms, and regulatory-based alerts based on artificial intelligence output 1420. The user interface secure portal 826 allows users to add comments to a specific event and/or period of time for others to review 1422. The summarize and conclude work stream 1406 provides the ability to publish a summarized report of a crew's operating performance for review and record keeping 1424. In some cases, the skills performance assessment provides an automated score-based recommendation for operator certification and/or de-certification 1426.

For simplicity of explanation, processes 1300 and 1400 are depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

The acceleration-based mobile asset data recorder and transmitter of an embodiment of the present invention used on locomotives comprises the operational integration of nine components. The components are an event recorder similar to a black box on airplanes, a locomotive digital video recorder, a fuel level sensor, fuel level sensor software, a wireless processing unit, an inertial navigation sensor board, firmware, system software, and the system encompassing these components. The inertial navigation sensor board includes a 3-axis digital gyroscope, a 3-axis digital magnetometer, a 3-axis digital accelerometer, and a micro-controller. The gyroscope is used for measuring the angular acceleration and deceleration of the asset, the magnetometer is used for measuring magnetic fields, the accelerometer is used for measuring linear accelerations and decelerations, and the micro-controller is used for processing data and communicating between the sensors and the wireless processing unit.

The mobile asset data recorder and transmitter performs seven functions: automatic orientation, automatic compass calibration, fuel compensation with pitch and roll, emergency brake with impact detection, rough operating condition detection, engine running detection and inertial navigation (dead reckoning).

Automatic collision detection alerts appropriate personnel when an emergency brake application occurs and can instantly determine if a collision coincides with the braking event. The mobile asset data recorder and transmitter provides immediate notification of collision severity including an indication of locomotive derailment or rollover event.

Rough operating condition detection reduces loss due to rough switching and train operations. It provides alerts and summary reports when high energy impacts are detected during switching operations. It also detects excessive slack-action, allowing supervisors to continuously assess and improve train operations. This enables the reduction of lading and equipment damage by identifying unsafe trends and allowing users to take immediate corrective action. Continuous monitoring of track conditions and over the road monitoring of vibration levels alert track maintenance personnel to the precise location of rough track or switches which may need inspection and repair.

Accelerometer-based engine running detection may be used as a backup source if the engine running signal is not already accessible from other onboard systems, as a means of reducing fuel costs by eliminating excess idle. It also improves over the road fuel accuracy by compensating for locomotive tilt due to grade and super elevation.

Fuel compensation with pitch and roll improves fuel reporting accuracy. It provides a simple, universal and non-intrusive method of determining if the engine is running while the locomotive is stopped. Increased accuracy provides enhanced real-time business intelligence to support strategic initiatives such as smart fueling, burn-rate analysis, fuel reconciliation and emissions monitoring.

Inertial navigation, or dead reckoning, enhances positioning accuracy. It augments the wireless processing unit's high accuracy differential GPS with sophisticated dead reckoning when inside shop buildings, stations, tunnels or any location where GPS signals are not available. This provides highly accurate station arrival and departure times, and the precise positioning and locomotive orientation within shop areas increases operational efficiency by improving shop planning and work flow.

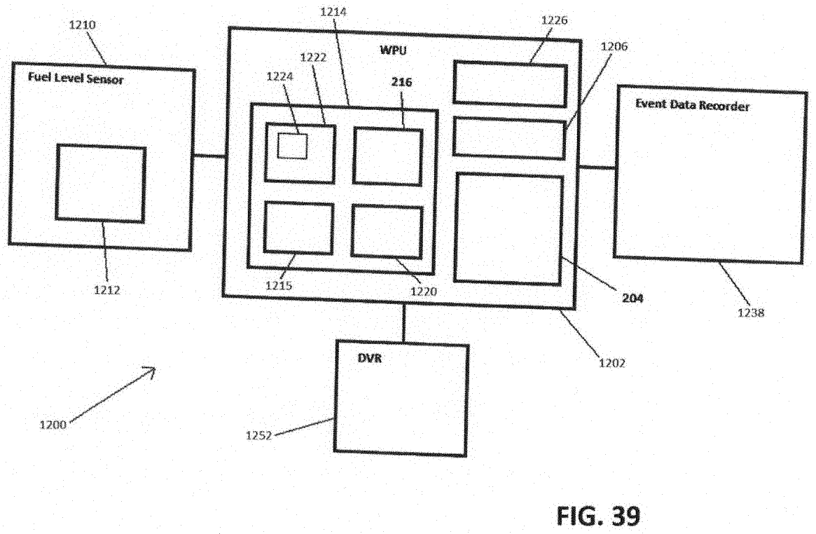

The mobile asset data recorder and transmitter system of the present invention and its components are shown in FIG. 39. The mobile asset data recorder and transmitter system 1200 consists of ten interrelated components: an event data recorder 1238, a locomotive digital video recorder (DVR) 1252, a fuel level sensor 1210, fuel level sensor software 1212, a WPU 1202, an inertial navigation sensor board 1214, global positioning system (GPS) 1206, firmware 1224, system software 1226, and the system 1200 itself. Installing the WPU 1202 onto an asset, such as a locomotive, consists of mounting the WPU 1202 and connecting it externally to event data recorder 1238, a locomotive digital video recorder 1252 and any additional available condition sensing devices.

The event data recorder 1238, similar to a black-box on airplanes, is an onboard data logging device for locomotives. A typical event data recorder 1238 consists of digital and analog inputs as well as pressure switches and pressure transducers which record data from various onboard devices, such as throttle position, wheel speed, and emergency brake application. The WPU 1202 receives and processes data from the event data recorder 1238 once per second over an external serial connection.

The locomotive digital video recorder (DVR) 1252, similar to a television DVR, is an onboard video recording device. The DVR 1252 comes equipped with a forward facing camera and a microphone. The camera is mounted at such orientation that it sees and records what the engineer sees. The WPU 1202 accesses the locomotive's DVR 1252 via an external Ethernet connection to download the video from the hard drive before, during, and after an event.

The fuel level sensor 1210 is a sensor that is used to measure the amount of fuel inside the fuel tank. The fuel level sensor 1210 used in the present invention is an ultrasonic level sensor which uses ultrasonic acoustic waves to determine the distance between the sensor head and the fuel level. The sensor 1210 is mounted on top of the fuel tank with known dimensions and mounting location. The WPU 1202 accesses this data via an external serial connection.

The fuel level sensor software 1212 takes the distance from the fuel level to the sensor 1210 with fuel tank geometry and converts this data into a steady fuel volume. This is accomplished by applying mathematical filtering to reduce noise from sloshing and ultrasonic behaviors of the tank. The software 1226 also uses smart algorithms to determine refuel and fuel drop events.

The WPU 1202 of the illustrated embodiment is a ruggedized onboard computer running Windows XP embedded specifically for industrial applications. It has many different features that can be installed to customize the product for specific customer needs. The WPU 1202 has the ability to communicate with a wide variety of onboard systems, including, but not limited to, vehicle control systems, event data recorders, DVRs, fuel level sensors, and engine controllers. The WPU 1202 has the ability to communicate over a wide variety of protocols, including, but not limited to, RS 232, RS 422, RS 485, CAN Bus, LAN, WiFi, cellular, and satellite.

The inertial navigation sensor board (Board) 1214 is a hardware upgrade for the WPU 1202. It is installed internally and communicates with the WPU 1202 via an internal serial port. The board 1214 consists of four components: a 3-axis gyroscope 1216, a 3-axis magnetometer 1215, a 3-axis accelerometer 1220, and a microcontroller 1222. The gyroscope 1216 is used for measuring angular accelerations, the magnetometer 1215 is used for measuring magnetic fields, the accelerometer 1220 is used for measuring linear accelerations and decelerations, and the microcontroller 1222 is used for processing data and communicating between the sensors and the WPU 1202.

The firmware 1224 runs on the Board's 1214 microcontroller 1222. The firmware 1224 constantly calculates pitch and roll using the 3-axis acceleration 1220 data. By comparing the 3-axis acceleration data to programmatically defined thresholds and durations, the firmware 1224 can determine if a trigger event occurs and if so, sends a trigger event message to the WPU 1202. Every second, the firmware 1224 sends a periodic data message containing a predefined set of values to the WPU 1202. This data is used for, but not limited to, determining heading, internal ambient temperature, and angular accelerations.

The system software 1226 is an application running on the WPU 1202. This application talks directly to the GPS 1206 and Board 1214 to gather related data. In addition to this data, the system software 1226, like all other applications on the WPU 1202, uses a standard inter-process communication protocol to gather data from other software applications. These other software applications are running on the WPU 1202 and communicate to other devices (DVR 1252, event data recorder 1238, etc.) which are physically connected to the WPU 1202. By using all the data gathered, the system software 1226 can compare the data to predefined thresholds and durations to determine if specific events have occurred.

The system 1200 consists of a WPU 1202 with a Board 1214, firmware 1224, and system software 1226 installed and an event data recorder 1238, a DVR 1252, and a fuel level sensor 1210. The system software 1226 runs on the WPU 1202, constantly correcting fuel levels and checking for event messages from the Board 1214 or event data recorder 1238 to take action.

The mobile asset data recorder and transmitter system 1200 (FIG. 39) performs seven functions: automatic orientation, automatic compass calibration, emergency brake with impact detection, fuel compensation with pitch and roll, rough operating condition detection, engine running detection and inertial navigation (dead reckoning). Each of these seven functions factors in signals generated by the 3-axis accelerometer 1220.

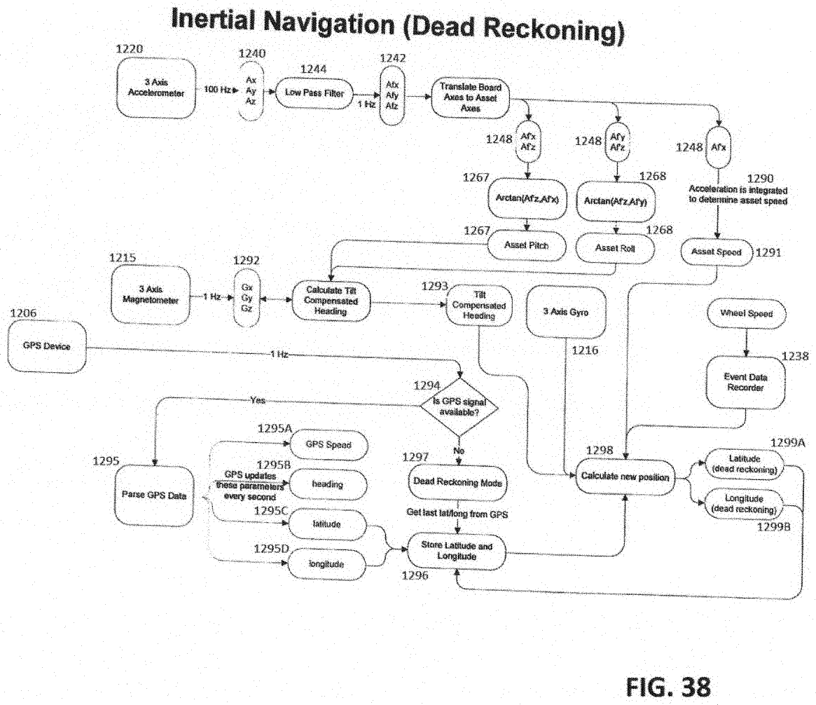

Auto orientation is used to correlate the axes of the WPU 1202 to the axes of the locomotive so that the values measured by the sensors correspond to the locomotive's axes. This process is accomplished by the software 1226 and firmware 1224. Due to different electronic environments on locomotives, the compass needs to be calibrated on a per locomotive basis. The software uses the WPU's 1202 GPS 1206 (FIGS. 38 and 39) to determine the heading of the locomotive. It then takes measurements from the magnetometer 1215 and stores them in the corresponding position of an array. The array consists of 360 positions, one for every degree of heading. Using these values, the WPU's 1202 software 1226 can correct for the locomotive's own magnetic fields and only detect the change due to the earth's magnetic field.

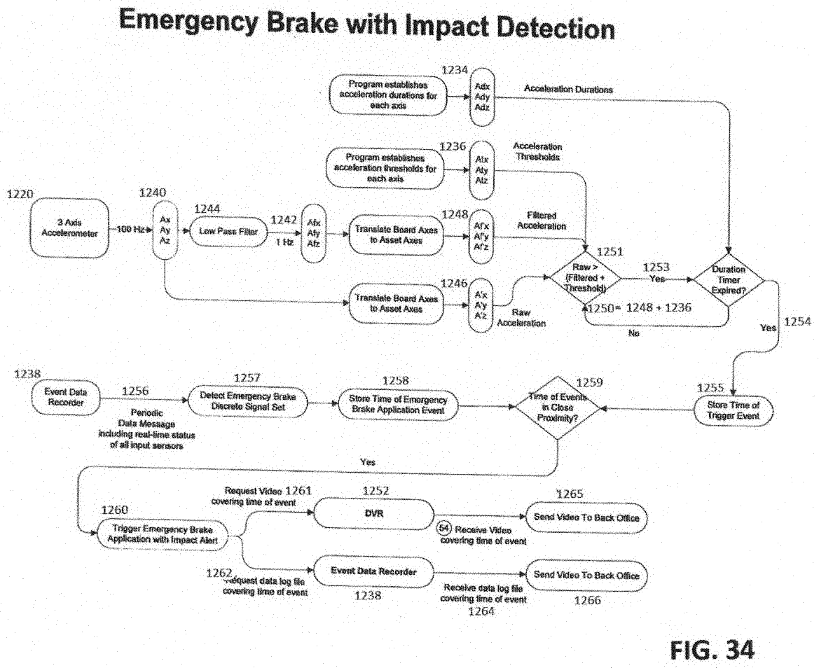

FIG. 34 depicts a flow diagram of a method application for emergency brake with impact detection. The WPU 1202 (FIG. 39) software 1226 (FIG. 39) sends initialization commands to the firmware 1224 (FIG. 39) to establish acceleration durations in each axis (Adx, Ady, Adz) 1234 to be used for triggering events. These durations are stored onboard in the device embodying system 1200. The WPU 1202 software 2226 also sends initialization commands to the firmware 1224 to establish acceleration thresholds in each axis (Atx, Aty, Atz) 1236 to be used for triggering events. These durations are stored onboard in the device embodying system 1200 (FIG. 39). The microcontroller 1222 (FIG. 39) pulls the raw 3-axis acceleration (Ax, Ay, Az) 1240 data from the accelerometer 1220 at a rate of 100 Hz. A low pass filter 1244 is applied to the raw acceleration values (Ax, Ay, Az) 1240, which results in filtered acceleration values (Afx, Afy, Afz) 1244. The Board 1214 (FIG. 39) axes of the filtered acceleration values (Afx, Afy, Afz) 1244 are translated to asset axes (Af′x, Af′y, Af′z) 1248. The Board 1214 values of the raw values (Ax, Ay, Az) 1240 are translated to asset axes (A′x, A′y, A′z) 1246. The filtered values of the asset axes (Af′x, Af′y, Af′z) 1248 are added to the established thresholds for each axis (Atx, Aty, Atz) 1236, and this added threshold (Af′tx, Af′ty, Af′tz) 1250 is then continually compared 1251 to the raw acceleration in the asset axes (A′x, A′y, A′z) 1246. When the raw values (A′x, A′y, A′z) 1246 exceed the thresholds 1250 in one or more axes, a timer is activated 1253. When a raw value 1246 no longer exceeds the thresholds 1250 in a specific axis 1256, the duration that the raw value 1246 exceeded the thresholds 1250 is evaluated to determine if the duration exceeds the specified duration for that axis (Adx, Ady, Adz) 1234. If the event duration was longer than 1254 the duration established (Adx, Ady, Adz) 1234, a trigger event is stored 1255, including specifics on which axis, duration of the event, and time of the trigger event. In parallel with this monitoring, the onboard software 1226 (FIG. 39) is receiving periodic data messages 1256 from an onboard event data recorder 1238, which is monitoring real-time status of various input sensors. The onboard software 1226 monitors the periodic data messages 1256 and detects when the periodic data message 1256 indicates an emergency brake application discrete signal has occurred 1257. The onboard software 1226 stores the time 1258 that the emergency brake application event occurred. If the onboard software 1226 stores either the trigger event 1255 or the emergency brake time 1258, the onboard system software 1226 will check the time stamp of each event to see if the latest two events logged, from the trigger event 1255 or emergency brake application 1258, are in close proximity 1259. If it is detected that the events occurred in close proximity 1259, the onboard software 1226 will trigger an emergency brake application with impact alert 1260 and will request a digital video recorder download 1261 covering the time of the event from the onboard DVR 1252 and will request the data log file covering the time of the event 1262 from the event data recorder 1238. The onboard software 1226 receives the downloaded video covering the time of the event 1263 and the data log file covering the time of the event 1264 and sends both to the back office 1265/1266.

Users will receive alerts indicating the actual force of the collision and if the collision resulted in a rollover or derailment. This, coupled with GPS location, video and immediate access to event recorder information, allows users to precisely relay the severity and scope of the incident to first responders as they are en route to an incident.

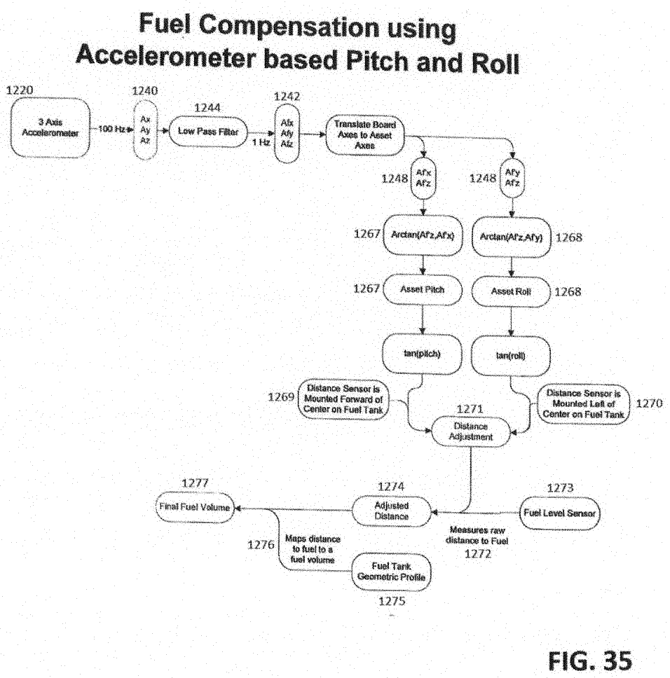

FIG. 35 depicts a flow diagram of a method application for fuel compensation using accelerometer-based pitch and roll. The WPU 1202 (FIG. 39) software 1226 (FIG. 39) pulls the raw 3-axis acceleration data (Ax, Ay, Az) 1240 from the accelerometer 1220 at a rate of 100 Hz. A low pass filter 1244 is applied to the raw data (Ax, Ay, Az) 1240, which results in filtered acceleration values (Afx, Afy, Afz) 1242. The Board 1214 (FIG. 39) axes of the filtered values (Afx, Afy, Afz) 1242 are translated to asset axes (Af′x, Af′y, Af′z) 1248. The asset's pitch 1267 is the arc tangent of the asset's filtered x-axis and the asset's filtered z-axis:

$$arctan ( \frac{x - axis translated filtered acceleration value}{z - axis translated filtered acceleration value} ) .$$

The asset's roll 1268 is the arc tangent of the asset's filtered y-axis and the asset's filtered z-axis:

$$arctan ( \frac{y - axis translated filtered acceleration value}{z - axis translated filtered acceleration value} ) .$$

For each model of asset the system is installed upon, the specific location of the fuel sensor mounting is captured. Specifically, the distance the sensor is mounted forward of the center of the fuel tank 1269 is recorded. In addition, the distance the fuel sensor is mounted left of the center of the fuel tank 1270 is also recorded.

The distance forward of center 1269 is combined with the tangent of the asset's pitch 1267 to obtain a first fuel distance adjustment. The distance left of center 1270 is combined with the tangent of the asset's roll 1268 to obtain a second fuel distance adjustment. The first and second fuel distance adjustments are combined to provide a single fuel distance adjustment 1271. The onboard distance level sensor records the distance from the top of the tank to the fuel level present in the onboard fuel tank. The raw distance to the fuel 1272 from the fuel sensor 1273 is combined with the distance adjustment 1271 to create an adjusted distance 1274. The adjusted distance 1274 is combined with a previously defined fuel tank geometric tank profile 1275, which maps a distance to fuel value to a fuel volume 1276. This results in a final fuel volume 1277, which is adjusted as the asset travels through various terrains in which the pitch 1267 and roll 1268 are changing, compensating for the movement of the liquid within the tank of an operating mobile asset.

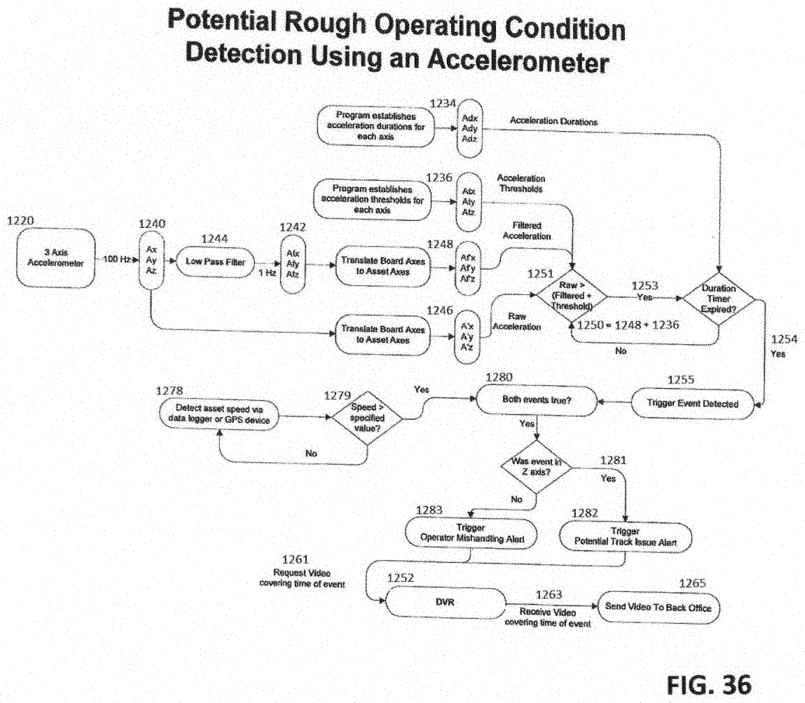

FIG. 36 depicts a flow diagram of a method application for potential rough operating condition detection using an accelerometer. The WPU 1202 (FIG. 39) software 1226 (FIG. 28) sends initialization commands to the firmware 1224 (FIG. 39) to establish acceleration durations in each axis (Adx, Ady, Adz) 1234 to be used for triggering events. These durations are stored onboard, in the device. The software 1226 also sends initialization commands to the firmware 1224 to establish acceleration thresholds in each axis (Atx, Aty, Atz) 1236 to be used for triggering events. These durations are stored onboard, in the device. The microcontroller 1222 (FIG. 39) pulls the raw 3-axis acceleration data (Ax, Ay, Az) 1240 from the accelerometer 1220 at a rate of 100 Hz. A low pass filter 1244 is applied to the raw acceleration values 1240, which results in filtered acceleration values (Afx, Afy, Afz) 1242. The Board 1214 (FIG. 39) axes of the filtered values 1242 are translated to asset axes (Af′x, Af′y, Af′z) 1248 and the Board 1214 axes of the raw values 1240 are translated to asset axes (A′x, A′y, A′z) 1246. The filtered values of the asset axes (Af′x, Af′y, Af′z) 1248 are added to the established thresholds for each axes (Atx, Aty, Atz) 1236, and then this added threshold (Af′tx, Af′ty, Af′tz) 1250 is continually compared 1251 to the raw acceleration in the asset axes (A′x, A′y, A′z) 1246. When a raw value 1246 exceeds the threshold 1250 in one or more axes, a timer is activated 1253. When a raw value 1246 no longer exceeds the threshold 1250 in a specific axis, the duration that the raw value 1246 exceeded the threshold 1250 is evaluated to determine if it exceeds the specified duration for that axis (Adx, Ady, Adz) 1234. If the event duration was longer than the duration established for that axis (Adx, Ady, Adz) 1234, a trigger event is stored 1255, including specifics on which axis, duration of the event, and time of the trigger event.

In parallel with this monitoring, the onboard software 1226 (FIG. 39) is monitoring asset speed via periodic messages from the onboard event data logger 1238 (FIG. 34) and/or from an onboard GPS device 1206 (FIGS. 38 and 39). The onboard software 1226 monitors the asset speed 1278 and detects when it exceeds a specified value 1279. If both the speed 1278 exceeds a specified value 1279 and a trigger event stored 1255 occur at the same time 1280, the onboard system software 1226 will check which axis the event was triggered in. If the event was triggered in the z-axis 1281, the system will log a potential track issue alert 1282. If the event was triggered in the x- or y-axis, the system will log an operator mishandling alert 1283. If either a potential track issue alert 1282 or an operator mishandling alert 1283 occurs, the onboard software 1226 will request a digital video recorder download 1261 covering the time of the event from the onboard DVR 1252. The onboard software 1226 receives the downloaded video 1263 and sends it to the back office 1265.

Users can now use the normal operation of their mobile assets to precisely locate and alert, in real-time, areas where their assets are encountering rough operating environment, such as bad track/switch, rough seas, and poor roads. The user will receive an alert, a still or video image and the crucial operational black-box data immediately upon identification of a rough operating environment. Repair teams can respond to the exact location of the bad road or track. Marine routes can be adjusted to avoid bar currents or choppy waters. The effectiveness of any repairs or rerouting can be validated when the next mobile asset data recorder and transmitter system equipped asset traverses any previously flagged area.

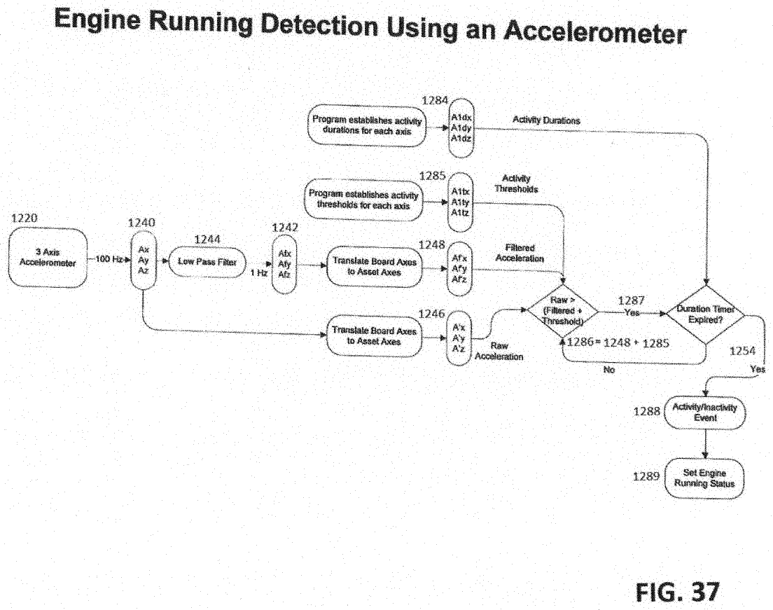

FIG. 37 depicts a flow diagram of a method application for engine running detection using an accelerometer. The WPU 1202 (FIG. 39) software 1226 (FIG. 39) sends initialization commands to the firmware 1224 (FIG. 28) to establish activity/inactivity durations in each axis (A1dx, A1dy, A1dz) 1284 to be used for triggering events. These durations are stored onboard, in the device. The WPU 1202 (FIG. 39) software 1226 (FIG. 39) also sends initialization commands to the firmware 1224 (FIG. 39) to establish activity/inactivity thresholds in each axis (A1tx, A1ty, A1tz) 1285 to be used for triggering events. These durations are stored onboard, in the device. The microcontroller 1222 (FIG. 39) pulls the raw 3-axis acceleration data (Ax, Ay, Az) 1240 from the accelerometer 1242 at a rate of 100 Hz. A low pass filter 1244 is applied to the raw acceleration values (Ax, Ay, Az) 1240, which results in filtered acceleration values (Afx, Afy, Afz) 1246. The Board 1214 (FIG. 39) axes of the filtered values 1246 are translated to asset axes (Af′z, Af′y, Af′z) 1248 and the Board 1214 axes of the raw values 1240 are translated to asset axes (A′x, A′y, A′z) 1249. The filtered values of the asset axes (Af′x, Af′y, Af′z) 1248 are added to the established activity/inactivity thresholds for each axis (A1tx, A1ty, A1tz) 1285 and then this added threshold (Af′1tx, Af′1ty, Af′1tz) 1286 is continually compared to the raw acceleration in the asset axes (A′x, A′y, A′z) 1249. When the raw value 1249 exceeds the threshold 1246 in one or more axes, a timer is activated 1287. If the raw value 1249 no longer exceeds the activity/inactivity threshold 1246 in a specific axis, the duration that the raw value 1249 exceeded the threshold 1286 is evaluated to determine if it exceeds the specified duration for that axis (Aldx, Aldy, Aldz) 1284. If the event duration was longer than the duration established for that axis (Aldx, Aldy, Aldz) 1284, a trigger inactivity/activity event 1254 is stored 1288, including specifics on which axis, duration of the event, and time of the event trigger. The engine running status is updated 1289 when activity/inactivity events are triggered.

FIG. 38 depicts a flow diagram of a method application for inertial navigation (dead reckoning). The microcontroller 1222 (FIG. 39) pulls the raw 3-axis acceleration data (Ax, Ay, Az) 1240 from the accelerometer 1242 at a rate of 100 Hz. A low pass filter 1244 is applied to the raw acceleration values (Ax, Ay, Az) 1240, which results in filtered acceleration values (Afx, Afy, Afz) 1246. The Board 1214 (FIG. 39) axes of the filtered values 1246 are translated to asset axes (Af′x, Af′y, Af′z) 1248, 1249. The asset's pitch 1267 is the arc tangent of the asset's filtered x-axis and the asset's filtered z-axis:

$$arctan ( \frac{x - axis translated filtered acceleration value}{z - axis translated filtered acceleration value} ) .$$

The asset's roll 1268 is the arc tangent of the asset's filtered y-axis and the asset's filtered z-axis:

$$arctan ( \frac{y - axis translated filtered acceleration value}{z - axis translated filtered acceleration value} ) .$$

Acceleration in the asset's x-axis is integrated 1290 to calculate the asset's speed 1291:
∫asset's acceleration_{x-axis translated filtered acceleration value}.
In parallel, the microcontroller 1222 (FIG. 39) pulls 3-axis gauss data (Gx, Gy, Gz) 1292 from the magnetometer 1215 at 1 Hz. Using the magnetometer data 1292 and the asset's pitch 1267 and roll 1268, a tilt compensated heading 1293 is calculated. Also in parallel, the onboard GPS device 1206 is providing location data updated at a 1 Hz frequency. The onboard software 1226 determines if valid GPS data is available 1294. If a GPS signal is available, the onboard software 1226 will parse the data 1295, into GPS speed 1295A, heading 1295B, latitude 1295C, and longitude 1295D every second, and will store 1296 the latitude 1295C and longitude 1295D. If the GPS data is determined to not be available, the system 1200 (FIG. 39) enters dead reckoning mode 1297. In dead reckoning mode 1297, the last known latitude 1295C and longitude 1295D are obtained from the GPS 1206 and stored 1296. Using the last known 1296 latitude 1295C and last longitude 1295D, along with the asset's speed 1291, the wheel speed from the event recorder data 1126, the tilt compensated heading 1293 and the data 1216 from the 3-axis gyroscope, a new position 1298 is calculated. The new latitude 1299A and the new longitude 1299B positions are stored and used, and the process continues until valid GPS data is again available.

Users will receive precision departure and arrival alerts and logging in environments where GPS signals are blocked or partially blocked by overhangs and canopies. This system 1200 (FIG. 39) allows users to define virtual ‘trip wires,’ even in areas where GPS devices are rendered useless due to RF signal loss or interference. The inertial navigation capabilities automate operator performance to a schedule matrix by alerting and logging the exact time an asset crosses a departure and arrival virtual ‘trip wire’ when a GPS signal cannot compute accurate location data.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for automating the assessment of performance skills of a specified mobile asset operator, comprising the steps of:
receiving, using a web portal, a request from a user comprising the specified mobile asset operator and a specified time range;
receiving, using a data acquisition and recording system, data related to the mobile asset operator and the specified time range, the data based on at least one signal from at least one of:
at least one data source onboard a mobile asset, the at least one data source onboard the mobile asset comprising at least one of at least one camera and at least one data recorder of the data acquisition and recording system; and
at least one data source remote from the mobile asset;
processing, using an artificial intelligence component of a video analytics system, the data into processed data;
displaying, using the web portal, the processed data including at least one video on a display device.

2. The method of claim 1, the at least one camera comprising at least one of at least one 360 degrees camera located in at least one of in the mobile asset, on the mobile asset, and in the vicinity of the mobile asset, at least one fixed camera located in at least one of in the mobile asset, on the mobile asset, and in the vicinity of the mobile asset, and at least one microphone located in at least one of in the mobile asset, on the mobile asset, and in the vicinity of the mobile asset, wherein the at least one 360 degrees camera is one of inward facing and outward facing and the at least one fixed camera is one of inward facing and outward facing.

3. The method of claim 1, the at least one data source onboard the mobile asset comprising at least one video recorder located in at least one of in the mobile asset, on the mobile asset, and in the vicinity of the mobile asset, at least one sound recorder located in at least one of in the mobile asset, on the mobile asset, and in the vicinity of the mobile asset, at least one accelerometer, at least one gyrometer, and at least one magnetometer.

4. The method of claim 1, the data comprising at least one of event data recorder data, accelerometer data, gyroscope data, fuel volume data, microphone data, inward camera data, and outward camera data.

5. The method of claim 1, further comprising:
storing, using an onboard data manager, at least one of the data and the processed data in at least one of a back office and at least one local memory component of a data recorder of the data acquisition and recording system; and
storing, using a remote data manager, at least one of the data and the processed data in a remote data repository.

6. The method of claim 1, the data comprising at least one of positive train control event logs and network dispatch system data.

7. The method of claim 1, further comprising:
continuously monitoring, using a back office, the data for critical events and regulatory requirements based on operational performance.

8. The method of claim 1, wherein the data acquisition and recording system receives the data via at least one of a wireless data link and a wired data link.

9. The method of claim 1, further comprising:
coordinating time-synchronized event recorder data and geographic position data with video of a cab of the specified mobile asset and of features adjacent to a course of travel of the specified mobile asset.

10. The method of claim 1, further comprising:
analyzing, using the video analytics system, the performance of the specified mobile asset operator by viewing the displayed data and comparing the displayed data to rules directed to safe operation of mobile assets.

11. The method of claim 1, further comprising:
analyzing, using the video analytics component, the data including operational data, performance data, and behavioral characteristics related to a predetermined geographic segment, the specified mobile asset operator, and the specified time range based on specified government regulatory requirements for one of certification and decertification of the specified mobile asset operator.

12. The method of claim 1, further comprising:
receiving, using the data acquisition and recording system, data related to the mobile asset operator and the specified time range, the data comprising at least one of fuel data, weather data, train consist data, and movement authority data for a specified course of movement of the mobile asset, crew data, and time data.

13. The method of claim 1, wherein displaying the processed data includes displaying at least one of critical geographic zones of operation, critical operational areas, work zones, regulatory-based alerts based on algorithms, and regulatory-based alerts based on output receiving from the artificial intelligence component.

14. The method of claim 1, further comprising:
receiving, using the web portal, user comments related to at least one of a specific event identified in the data and a period of time identified in the data; and
displaying, using the web portal, the user comments.

15. The method of claim 1, further comprising:
generating a summarized report of the specified mobile asset operator's performance; and
displaying, using the web portal, the summarized report.

16. The method of claim 1, further comprising:
determining an automated score-based recommendation for one of certification and decertification of the specified mobile asset operator.

17. A system for automating the assessment of performance skills of a specified mobile asset operator, comprising:
a web portal adapted to receive a request from a user comprising the specified mobile asset operator of a mobile asset and a specified time range;
a data acquisition and recording system onboard the mobile asset adapted to receive data related to the specified mobile asset operator and the specified time range, the data based on at least one signal from at least one of at least one data source onboard the mobile asset comprising at least one of at least one camera and at least one data recorder of the data acquisition and recording system and at least one data source remote from the mobile asset; and
an artificial intelligence component of a video analytics system adapted to process the data into processed data;
the web portal adapted to display the processed data including at least one video on a display device.

18. The system of claim 17, the at least one camera comprising at least one of at least one 360 degrees camera located in at least one of in the mobile asset, on the mobile asset, and in the vicinity of the mobile asset, at least one fixed camera located in at least one of in the mobile asset, on the mobile asset, and in the vicinity of the mobile asset, and at least one microphone located in at least one of in the mobile asset, on the mobile asset, and in the vicinity of the mobile asset, wherein the at least one 360 degrees camera is one of inward facing and outward facing and the at least one fixed camera is one of inward facing and outward facing.

19. The system of claim 17, the at least one data source onboard the mobile asset comprising at least one video recorder located in at least one of in the mobile asset, on the mobile asset, and in the vicinity of the mobile asset, at least one sound recorder located in at least one of in the mobile asset, on the mobile asset, and in the vicinity of the mobile asset, at least one accelerometer, at least one gyrometer, and at least one magnetometer.

20. The system of claim 17, the data comprising at least one of event data recorder data, accelerometer data, gyroscope data, fuel volume data, microphone data, inward camera data, and outward camera data.

21. The system of claim 17, further comprising:
an onboard data manager of the data acquisition and recording system adapted to store at least one of the data and the processed data in at least one of a back office and at least one local memory component of a data recorder of the data acquisition and recording system; and
a remote data manager adapted to store at least one of the data and the processed data in a remote data repository.

22. The system of claim 17, the data comprising at least one of positive train control event logs and network dispatch system data.

23. The system of claim 17, further comprising:
a back office adapted to continuously monitor the data for critical events and regulatory requirements based on operational performance.

24. The system of claim 17, the data acquisition and recording system further adapted to receive the data via at least one of a wireless data link and a wired data link.

25. The system of claim 17, the data acquisition and recording system further adapted to coordinate time-synchronized event recorder data and geographic position data with video of a cab of the specified mobile asset and of features adjacent to a course of travel of the specified mobile asset.

26. The system of claim 17, the video analytics system further adapted to analyze the performance of the specified mobile asset operator by viewing the displayed data and compare the displayed data to rules directed to safe operation of mobile assets.

27. The system of claim 17, the video analytics system further adapted to analyze the data including operational data, performance data, and behavioral characteristics related to a predetermined geographic segment, the specified mobile asset operator, and the specified time range based on specified government regulatory requirements for one of certification and decertification of the specified mobile asset operator.

28. The system of claim 17, the data acquisition and recording system further adapted to receive data related to the mobile asset operator and the specified time range, the data comprising at least one of fuel data, weather data, train consist data, and movement authority data for a specified course of movement of the mobile asset, crew data, and time data.

29. The system of claim 17, the web portal adapted to display the processed data including displaying at least one of critical geographic zones of operation, critical operational areas, work zones, regulatory-based alerts based on algorithms, and regulatory-based alerts based on output receiving from the artificial intelligence component.

30. The system of claim 17, the web portal further adapted to receive user comments related to at least one of a specific event identified in the data and a period of time identified in the data and adapted to display the user comments.

31. The system of claim 17, the data acquisition and recording system further adapted to generate a summarized report of the specified mobile asset operator's performance and the web portal further adapted to display the summarized report.

32. The system of claim 17, the data acquisition and recording system further adapted to determine an automated score-based recommendation for one of certification and decertification of the specified mobile asset operator.
